(19) United States
(12) Patent Application Publication
(10) Pub. No.: US 2006/0098236 A1
(43) Pub. Date: May 11, 2006

(54) Photo printing control apparatus, photo printing control method, and program

(75) Inventors: Taketoshi Yamashita, Saitama (JP); Shigeki Washino, Kanagawa (JP); Yoshiharu Hibi, Kanagawa (JP); Erika Tani, Kanagawa (JP); Shinichi Utsumi, Kanagawa (JP); Shinichi Kobayashi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 10/975,041

(22) Filed: Oct. 28, 2004

(51) Int. Cl. H04N 1/23

(52) U.S. Cl. 358/302

(57) ABSTRACT

A photo printing control apparatus has a photo data acquisition unit which obtains photo data for which printing is requested; a location information generator for generating location information; a photo data saving unit which saves the photo data in a storage location indicated by the location information; a location information embedding unit which embeds location information in photo data; a printing instruction unit which instructs photo printing based on the photo data wherein the location information is embedded; a location information acquisition unit which extracts location information from a photo for which copying is requested; and a photo data reading unit which reads photo data from the storage location indicated by the location information, and which transmits the photo data to the printing instruction unit.

### BACKGROUND OF THE INVENTION

1. Field of the Invention

The present invention relates to a photo printing apparatus, and a photo printing control method, and a program, having a photo printing function based on photo data obtained by a digital camera, for example, or a photo copy function for photos printed using a printing function.

2. Description of the Related Art

When a photo printed on paper, such as size L paper, is to be copied, the photo can be reprinted so long as photo data, which are digital data used as the material for the photo, are available. However, when such photo data are not available, conventionally there is no other choice but to directly copy the pertinent photo using a copier (see, for example, JP-A-2003-098915).

JP-A-2003-098915 is referred to as a related art.

When photos are copied using copiers, however, the image quality of the photos is degraded. Although thus obtained photo copies have become clearer as copying techniques have been developed; the deterioration of image quality in photo copies can not be avoided because, unlike prints obtained based on original photo data, copies are obtained by scanning photos on paper. Further, as time elapses, changes, such as discoloration, occur in photos printed on paper, and when photos that have thus been changed are directly copied, only photos having poor image quality are obtained.

Furthermore, when a copier is employed to copy a photo, image loss occurs. Generally, a copier scans a slightly enlarged range, while taking into account that when a photo is placed on a platen it is slightly shifted or turned, and cuts off a peripheral portion whereat an affect due to the shifting or turning appears. Therefore, when a frameless photo is copied, the peripheral portion of the photo would be cut off. In JP-A-2003-098915, a countermeasure for image loss for a frameless photo is described. However, this technique merely adjusts the photo scanning magnification rate to prevent the loss of the peripheral portion of a photo, and does not respond to a request to acquire a photo having the same size as the original photo with no image loss.

In addition, a function for limiting the production of copies of a printed photo and a function for limiting the production of other copies (so-called generation copies) of a printed photo are not provided for a copier. Thus, copies can be produced freely of one original photo used as the original.

### SUMMARY OF THE INVENTION

The present invention provides a photo printing control apparatus, a photo printing control method and a program, for employing photo data for an original photo to print a photo equivalent to the original photo.

According to the present invention, when a photo is to be printed based on photo data, the photo data are stored in the machine of a user or a server computer (hereinafter referred to simply as a server) on a network, and information constituting a key for reading the stored photo data is embedded in a medium.

Therefore, the present invention provides a photo printing control apparatus having:

a photo data saving unit which saves photo data in a storage unit in accordance with a request for photo printing based on the photo data;

an information embedding unit which embeds, in the photo data, information designating a storage location for the photo data, and thus generates advanced photo data; and

a printing instruction unit which instructs photo printing based on the advanced photo data that are generated by the information embedding unit.

Further, according to the present invention, in photo printing based on photo data, the photo data are saved by the machine of a user or by a server on a network, and information serving a key for reading the saved photo data is maintained in the machine or the server.

Thus, the present invention provides a photo printing control apparatus having:

a photo data saving unit which saves photo data in a storage unit in accordance with a request for photo printing based on the photo data;

a printing instruction unit which instructs printing of a photo based on the photo data;

an identification information acquisition unit which obtains identification information that is attached in advance to a medium on which the photo is printed; and

a photo management information saving unit which saves, in the storage unit, photo management information that includes a correlation between identification information, which is obtained by the identification information acquisition unit, and location information, which indicates a storage location for the photo data. The information embedding unit may embed information in the photo data to specify a permission level for performing printing based on the photo data.

Furthermore, according to the present invention, when copying of a photo is requested, based on the information that is maintained and serves as the key in the above described manner, the photo data are read from the machine of the user or from the server, and are printed.

the present invention, therefore, provides a photo printing control apparatus having:

an information acquisition unit, upon receiving a request for copying a photo, which extracts information from the photo to designate a storage location for photo data for the photo;

a photo data reading unit which reads photo data from the storage location designated in accordance with the information obtained by the information acquisition unit; and

a printing instruction unit which instructs photo printing based on the photo data obtained by the photo data reading unit.

Moreover, the present invention provides a photo printing control method having the steps of:

saving photo data in a storage unit in accordance with a request for photo printing based on the photo data;

embedding, in the photo data, information designating a storage location for the photo data, and thus generating advanced photo data; and

instructing photo printing based on the advanced photo data that are generated.

Furthermore, the present invention provides a photo printing control method having the steps of:

saving photo data in a storage unit in accordance with a request for photo printing based on the photo data;

instructing printing of a photo based on the photo data;

obtaining identification information that is attached in advance to a medium on which the photo is printed; and

saving, in the storage unit, photo management information that includes a correlation between identification information, which has been obtained, and location information, which indicates a storage location for the photo data.

Further, the present invention provides a photo printing control method having the steps of:

upon receiving a request for copying a photo, extracting information from the photo to designate a storage location for photo data for the photo;

reading photo data from the storage location designated in accordance with the obtained information; and

instructing photo printing based on the obtained photo data.

In addition, the present invention provides a program executed by a computer to perform the functions of:

saving image data in a storage unit in accordance with a request for image printing based on the image data;

embedding, in the image data, information designating a storage location for the image data, and thus generating advanced image data; and

instructing image printing based on the advanced image data that are generated.

Further, the present invention provides a program executed by a computer to perform the functions of:

saving image data in a storage unit in accordance with a request for image printing based on the image data;

instructing printing of an image based on the image data;

obtaining identification information that is attached in advance to a medium on which the image is printed; and

saving, in the storage unit, image management information that includes a correlation between identification information, which is obtained, and location information, which indicates a storage location for the image data.

Furthermore, the present invention provides a program executed by a computer to perform the functions of:

upon receiving a request for copying an image, extracting information from the image to designate a storage location for image data for the image;

reading image data from the storage location designated in accordance with the obtained information; and

instructing image printing based on the obtained image data.

As is described above, as though a photo printed on a medium, such as paper, were to be copied by a copier, control can be exercised for printing of a photo equivalent to the original photo by using photo data for the original photo.

The present invention provides a photo printing control apparatus, a photo printing control method, and a program, whereby the use of photo data for a photo that has been printed is inhibited in order to prevent the unrestricted printing of photos having the same quality as the photo that has been printed.

According to the present invention, for photo printing based on photo data, the photo data are saved in the machine of a user or in a server computer (hereinafter referred to simply as a server) on a network, and information indicating a permission level for printing based on the saved photo data is embedded in the photo.

Therefore, the present invention provides a photo printing control apparatus having:

a photo data saving unit, upon receiving a request for photo printing based on photo data, which saves the photo data in a storage unit;

an information embedding unit which embeds information in the photo data to specify a permission level for printing based on the photo data, and thus generating advanced photo data; and

a printing instruction unit which instructs photo printing based on the advanced photo data generated by the information embedding unit. The information embedding unit may embed information in the photo data to designate a storage location for the photo data.

In addition, according to the present invention, for photo printing based on photo data, the photo data are saved in the machine of a user or in a server on a network, and information indicating a printing permission level based on the stored photo data is maintained in the machine or in the server.

Thus, the present invention provides a photo printing control apparatus having:

a photo data saving unit, upon receiving a request for photo printing based on photo data, which saves the photo data in a storage unit;

a printing instruction unit which instructs the printing of a photo based on the photo data;

an identification information acquisition unit which obtains identification information that is attached in advance to a medium on which the photo is printed; and

a photo management information saving unit which saves photo management information that includes a correlation between the identification information, which is obtained by the identification information acquisition unit, and permission information, which indicates a permission level for performing printing based on the photo data.

Moreover, according to the present invention, upon receiving a request to copy a photo, whether printing should be permitted is determined based on the thus maintained information indicating the printing permission level. When printing is permitted, photo data are read from the machine of a user or from the server, and are printed.

Therefore, the present invention provides a photo printing control apparatus having:

an information acquisition unit, upon receiving a request to copy a photo, which extracts information from the photo to identify a permission level for printing based on photo data for the photo;

a photo data reading unit, when it is determined, based on the permission level designated by the information obtained by the information acquisition unit, that printing based on the photo data is permitted, which reads the photo data from the storage unit; and

a printing instruction unit which instructs photo printing based on the photo data that are read by the photo data reading unit.

Further, the present invention provides a photo printing control method having the steps of:

upon receiving a request for photo printing based on photo data, saving the photo data in a storage unit;

embedding information in the photo data to specify a permission level for printing based on the photo data, and thus generating advanced photo data; and

instructing photo printing based on the advanced photo data that are generated.

In addition, the present invention provides a photo printing control method having the steps of:

upon receiving a request for photo printing based on photo data, saving the photo data in a storage unit;

instructing the printing of a photo based on the photo data;

obtaining identification information that is attached in advance to a medium on which the photo is printed; and

saving photo management information that includes a correlation between the obtained identification information and permission information that indicates a permission level for performing printing based on the photo data.

Moreover, the present invention provides a photo printing control method having the steps of:

upon receiving a request to copy a photo, extracting information from the photo to identify a permission level for printing based on photo data for the photo;

when it is determined, based on the permission level designated by the obtained information, that printing based on the photo data is permitted, reading the photo data from the storage unit; and

instructing photo printing based on the photo data that are read.

Further, the present invention provides a program executed by a computer to perform the functions of:

upon receiving a request for image printing based on image data, saving the image data in a storage unit;

embedding information in the image data to specify a permission level for printing based on the image data, and thus generating advanced image data; and

instructing image printing based on the advanced image data that are generated.

In addition, the present invention provides a program executed by a computer to perform the functions of:

upon receiving a request for image printing based on image data, saving the image data in a storage unit;

instructing the printing of an image based on the image data;

obtaining identification information that is attached in advance to a medium on which the image is printed; and

saving image management information that includes a correlation between the obtained identification information and permission information that indicates a permission level for performing printing based on the image data.

Moreover, the present invention provides a program executed by a computer to perform the functions of:

upon receiving a request to copy an image, extracting information from the image to identify a permission level for printing based on image data for the image;

when it is determined, based on the permission level designated by the obtained information, that printing based on the image data is permitted, reading the image data from the storage unit; and

instructing image printing based on the image data that are read.

In this manner, the usage of photo data for a photo that has been printed can be inhibited to prevent the unrestricted printing of photos having the same quality as the photo that has been printed.

### BRIEF DESCRIPTION OF THE DRAWINGS

FIG. 1 is a block diagram showing the hardware configuration of a system for which a photo printing control apparatus according to the present invention is applied;

FIG. 2 is a block diagram showing a processing apparatus according to a first embodiment of the present invention;

FIG. 3 is a flowchart showing a printing operation for the first embodiment;

FIG. 4 is a diagram showing an example photo that is printed according to first and second embodiments of the present invention;

FIG. 5 is a flowchart showing a copying operation for the first embodiment;

FIG. 6 is a block diagram showing a processing apparatus according to the second embodiment;

FIG. 7 is a diagram showing example photo management information that is registered according to a second and a third embodiment;

FIG. 8 is a flowchart showing a printing operation for the second embodiment;

FIG. 9 is a flowchart showing a copying operation for the second and third embodiments;

FIG. 10 is a diagram showing other example photo management information that is registered according to the second embodiment;

FIG. 11 is a block diagram showing a processing apparatus according to the third embodiment;

FIG. 12 is a flowchart showing a printing operation for the third embodiment;

FIG. 13 is a block diagram showing a processing apparatus according to a fourth embodiment of the present invention;

FIG. 14 is a flowchart showing a printing operation for the fourth embodiment;

FIG. 15 is a flowchart showing a copying operation for the fourth embodiment;

FIG. 16 is a block diagram showing a processing apparatus according to a fifth embodiment of the present invention;

FIG. 17 is a flowchart showing a printing operation for the fifth embodiment;

FIG. 18 is a diagram showing example photo management information that is registered according to a fifth and a sixth embodiment;

FIG. 19 is a flowchart showing a copying operation for the fifth and sixth embodiments;

FIG. 20 is a block diagram showing a processing apparatus according to the sixth embodiment; and

FIG. 21 is a flowchart showing a printing operation for the sixth embodiment.

### DETAILED DESCRIPTION OF THE PREFERRED EMBODIMENTS

A photo printing control apparatus, and a photo printing control method and a program, will now be described in detail, according to embodiments of the present invention, while referring to the drawings.

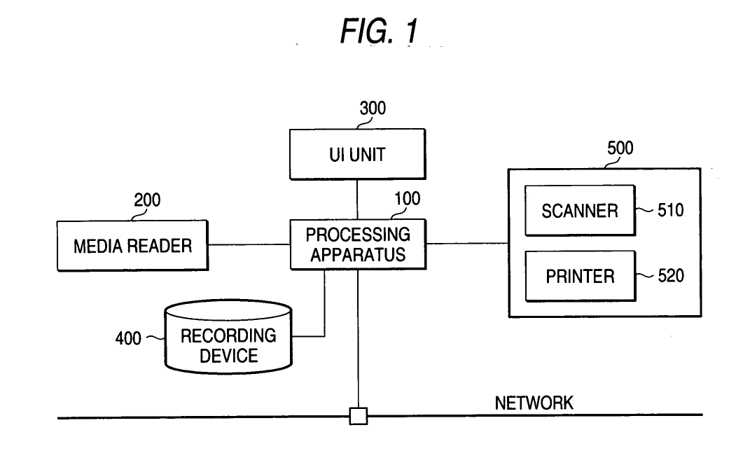

In FIG. 1 is shown an example hardware configuration for a system to which the photo printing control apparatus of the invention is applied. This system has: a processing apparatus 100, a media reader 200, a UI (User Interface) unit 300, a storage unit 400 and a copier 500.

The processing apparatus 100 is, for example, a personal computer, and includes a central processing unit (CPU), a main memory and a bus for interconnecting these components (none of them shown).

The media reader 200 has a function for reading photo data from a recording medium, such as a flash memory, that is employed by a digital camera.

The UI unit 300 is a manipulation component for a user for the input and output of information, and is, for example, a touch panel display device.

The storage device 400 is, for example, a hard disk device (HDD) that serves as a storage area for photo data and also as a storage area for a program that controls the processing apparatus 100 and data required for exercising control.

The copier 500 includes: a scanner 510, for reading a document placed on a platen; and a printer 520, for transferring to a sheet an image that has been read and outputting the sheet. The scanner 510 may be a double-sided scanner that scans, at the same time, the obverse side and the reverse side of a document that is placed on the platen. The printer 520 may be a double-sided printer that prints different data on the obverse and reverse sides of a sheet using a single operation.

In first to third embodiments that will be described below, during photo printing based on photo data, the photo data are saved in the machine of a user or in a server, and information used as a key for reading the stored photo data is maintained, so that a photo equivalent to the original photo can be printed by using the photo data for the original photo, as though a photo printed on a medium, such as paper, were being copied by a copier. It should be noted that a photo is printed on paper that is, as an example, of size L.

### First Embodiment

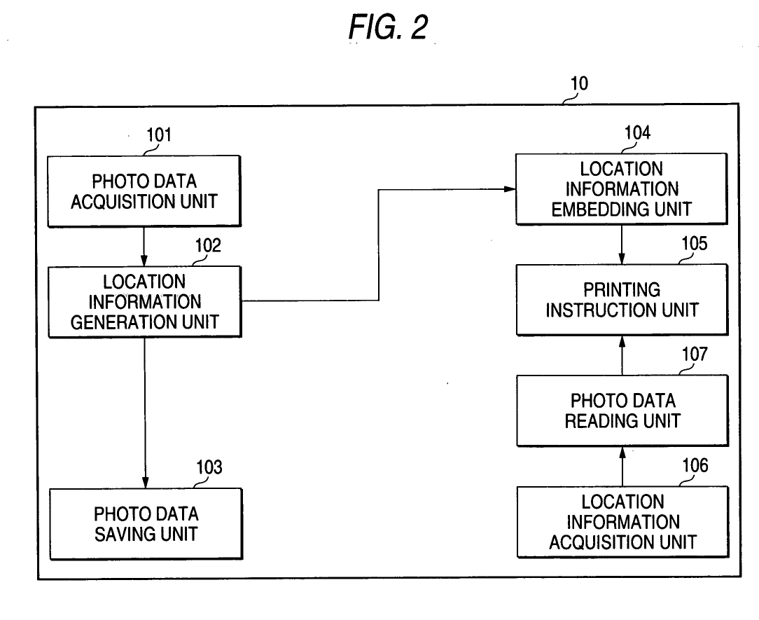

FIG. 2 is a block diagram showing a processing apparatus 10 according to the first embodiment.

As is shown in FIG. 2, the processing apparatus 10 for the first embodiment has: a photo data acquisition unit 101, a location information generator 102, a photo data saving unit 103, a location information embedding unit 104, a printing instruction unit 105, a location information acquisition unit 106 and a photo data reader 107.

The photo data acquisition unit 101 obtains photo data that are read by the media reader 200 and are designated using the UI unit 300. The location information generator 102 generates location information indicating the storage location for photo data. The photo data saving unit 103 saves photo data at the storage location indicated by the location information. The location information embedding unit 104 embeds location information in photo data. The printing instruction unit 105 issues an instruction to the printer 520 to perform printing based on designated print data. The location information acquisition unit 106 obtains location information from an image read by the scanner 510. And the photo data reader 107 reads photo data from the storage location indicated by the location information.

The location information embedding unit 104 may embed information to specify the storage location of photo data. The photo data in which the location information is embedded may be photo data wherein information is embedded specifying the storage location of the photo data.

Further, the location information acquisition unit 106 may obtain information in order to specify the storage location of photo data that are the base for a photo that was scanned.

The operation of the processing apparatus 10 in this embodiment will now be explained.

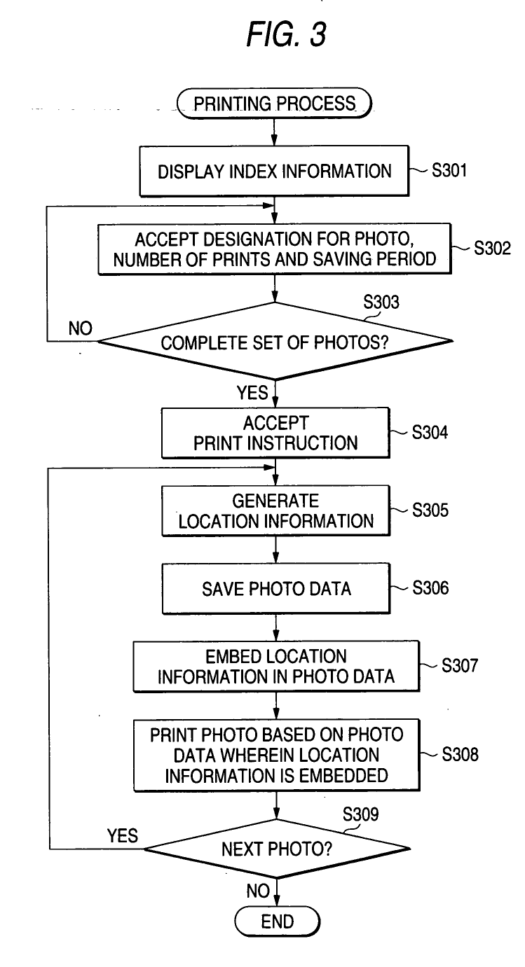

FIG. 3 is a flowchart showing the printing operation based on photo data.

First, the processing apparatus 10 reads index information (e.g., thumbnail images) for photos that are recorded on a recording medium by the media reader 200, and displays the information on the UI unit 300 (step S301). Then, after a user has examined the index information on the display and designated the number of prints and a saving period for a desired photo, the processing apparatus 10 accepts this designation entered via the UI unit 300 (step S302). A check is then performed to determine whether the selection has been completed for all the photos (step S303). When the selection has not yet been completed, program control returns to step S302. When the selection process has been completed, a printing start instruction is accepted from the user (step S304).

Thereafter, the photo data acquisition unit 101 obtains, from the recording medium through the media reader 200, photo data for photos selected by the user.

Following this, for one set of photo data obtained by the photo data acquisition unit 101, the location information generator 102 generates location information indicating a storage location whereat the photo data are to be saved (step S305). The location information referred to here can be directory information or file information for the machine of the user when the photo data are to be saved in the machine, or can be a URL (Uniform Resource Locator) when the photo data are to be saved in a server.

The photo data saving unit 103 saves photo data at a storage location indicated by the thus generated location information (step S306). At this time, the saving period for the photo data may be transmitted to the computer whereat the photo data are saved, and when the saving period has expired, the photo data may be automatically erased.

The location information embedding unit 104 embeds the location information as a watermark in the photo data (step S307).

Finally, the printing instruction unit 105 sets, into print data, the photo wherein the watermark is embedded, and instructs the printer 520 to print the photo (step S308).

Thereafter, the processing apparatus 10 determines whether there is a next photo (step S309). When there is a next photo, program control returns to step S305. When there is not another photo, the processing is terminated.

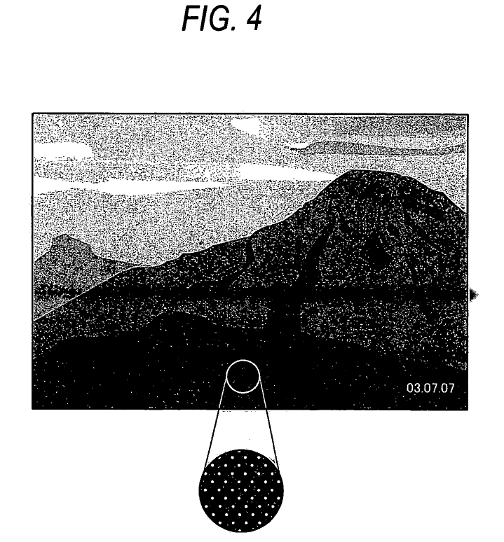

Through this processing, the printer 520 prints the photo wherein the watermark representing the storage location is embedded. In FIG. 4 is shown an example photo that has thus been printed. The watermark is represented, for example, by a dot pattern, as shown in an enlarged circular area. This dot pattern is not discernible to the naked eye of a human being when viewing the photo.

The dot pattern should not be one that naturally appears in photo data, but must be one that can be understood as having been intentionally embedded. As a first method for embedding such a dot pattern, a black dot pattern can be embedded in the low density area of a photo. For example, a pattern of tiny dots is embedded in the solid-white letters of the date (“103.07.07” in FIG. 4) in the photo. As a second method, in a specific area having a single color, a dot pattern using the complementary color can be embedded.

Methods for the embedding of watermarks are not limited to these, and any method can be employed so long as a difference before and after a watermark is embedded can not be detected by the human eye, but so long as the watermark can be detected when the photo is to be copied.

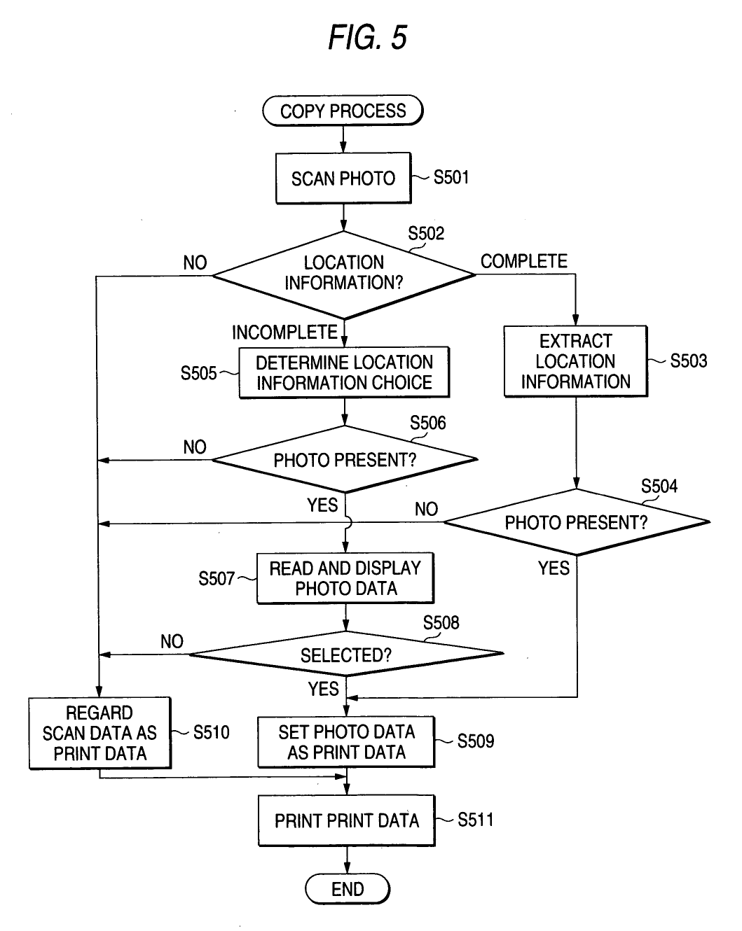

FIG. 5 is a flowchart showing the operation performed in the embodiment for the copying of a printed photo.

First, the scanner 510 of the copier 500 scans a photo printed on paper that is, as an example, size L (step S501), and transmits the results to the processing apparatus 10. Then, the location information acquisition unit 106 determines whether location information can be extracted from the photo that was scanned (step S502).

The location information acquisition unit 106 analyzes the photo scanning results in the same manner as when location information has been embedded, and attempts to extract the location information. When the location information has been embedded in an area from which it is easily extracted, and when discoloration that renders extraction of location information difficult does not occur in the photo, the location information can be extracted by analyzing the scanning results obtained during the same procedures. However, in other cases, the location information may not be extracted at all, or may only partially be extracted. Therefore, in this embodiment, three cases are assumed that are representative of the results obtained for a determination made when ascertaining whether location information can be obtained: a case wherein complete location information can be extracted, a case wherein location information is extracted only incompletely (wherein, although initially incomplete information is obtained, premised on automatic compensation provided for the insufficient portion, complete location information can be assumed), and a case wherein no location information can be extracted.

The location information acquisition unit 106 extracts location information when it is determined that the location information can be extracted in a complete form (step S503). Then, the photo data reader 107 determines whether photo data are present at the storage location indicated by the location information (step S504). When photo data are present, the photo data are read and designated as print data (step S509).

When it is determined at step S502 that the location information is to be extracted in an incomplete form, the location information acquisition unit 106 automatically compensates for the part of the location information that is incomplete, assumes that the form of the location information is complete, and determines several location information choices (step S505). Following this, the photo data reader 107 determines whether photo data are present at the storage locations indicated by these location information choices (step S506). When photo data are found at the storage locations indicated by the location information choices, the photo data are read from these storage locations and are displayed on the UI unit 300 (step S507). Then, when the user selects a desired photo to be copied, the UI unit 300 accepts the selection (step S508). Thereafter, the photo data reader 107 designates photo data for the selected photo as print data (step S509).

When the location information can not be extracted at all at step S502, when photo data are not present at step S504, when photo data are not present at step S506, or when the selection is not entered at step S508, the photo that was scanned at step S501 is designated directly as print data (step S510).

The printing instruction unit 105 then instructs the printer 520 to print the print data (step S511), so that the printing of the photo is initiated.

In the flowchart in FIG. 5, when the location information is obtained in an incomplete form, the complete location information is assumed, and choices for a photo a user desires to copy are presented. However, for a system that can be employed by a large, unspecified number of users, an invasion of privacy may occur when photos owned by one specific user are presented as choices to another user for a photo to be copied. Therefore, if such a concern is present, when it is determined at step S502 that the location information is incomplete, program control may not perform the processes at step S505 to S508, and instead, may advance to step S510, as is done when it is determined that location information is absent.

In this embodiment, the method used to charge for a service can be one incorporating a coin kit system. That is, on condition that a predetermined amount of money must be inserted into a coin-operated machine, the processes at steps S301 to S309 are performed for the printing process in FIG. 3, or the processes at steps S501 to S511 are performed for the copy process in FIG. 5.

Further, charging for a photo data storage service can also be performed during the printing of a photo. That is, a charging unit can be provided that requests at step S304 that an amount of money be inserted corresponding to the saving period designated at step S302, and that performs the processes at steps S305 to S309 when the condition has been satisfied by the insertion of the money.

As is described above, according to the embodiment, during the printing of a photo, photo data are saved in the machine of a user or in a server, and location information representing the storage location is embedded in the photo. Thus, during the copying of a photo, the storage location of the photo data can be designated based on the location information embedded in the photo, and the photo data can be read from the storage location in the machine or the server and be printed. As a result, just as though the photo were being copied by a copier, a photo equivalent to the original photo can be printed using the photo data for the original photo.

### Second Embodiment

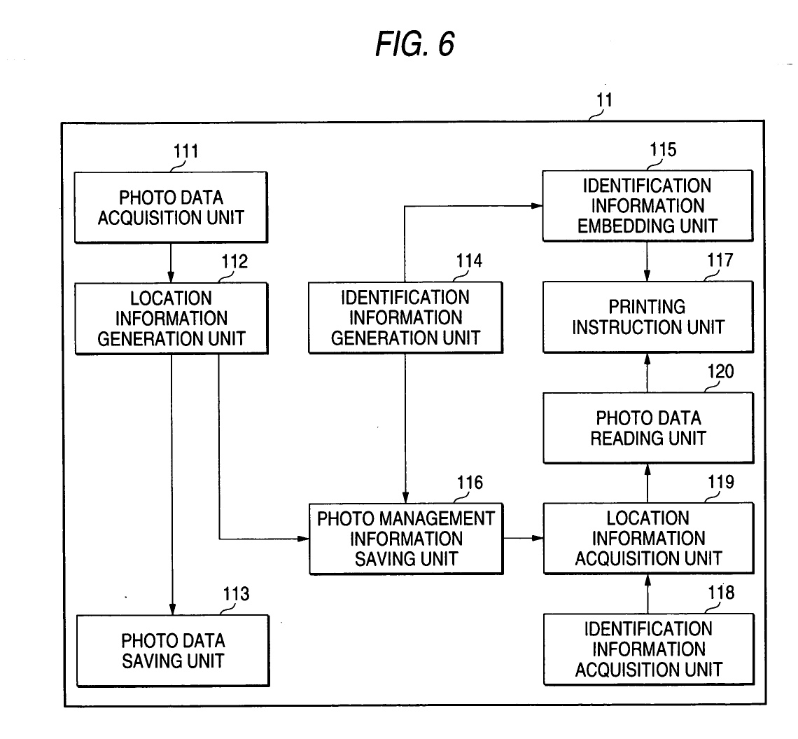

FIG. 6 is a block diagram showing a processing apparatus 11 according to the second embodiment.

As is shown in FIG. 6, the processing apparatus 11 of the second embodiment has: a photo data acquisition unit 111, a location information generator 112, a photo data saving unit 113, an identification information generator 114, an identification information embedding unit 115, a photo management information saving unit 116, a printing instruction unit 117, an identification information acquisition unit 118, a location information acquisition unit 219, and a photo data reader 120.

The photo data acquisition unit 111 obtains photo data that are read by the media reader 200 and designated by the UI unit 300, and the location information generator 112 generates location information indicating the storage location of the photo data. The photo data saving unit 113 stores the photo data at the storage location indicated by the location information. The identification information generator 114 generates identification information for uniquely identifying the photo data. The identification information embedding unit 115 embeds identification information in the photo data. The photo management information saving unit 116 saves photo management information, such as identification information and location information. The printing instruction unit 117 issues an instruction to the printer 520 to perform printing based on the designated print data. The identification information acquisition unit 118 obtains identification information from an image that is read by the scanner 510. The location information acquisition unit 219 obtains location information that corresponds to the identification information. And the photo data reader 120 reads photo data from the storage location indicated by the location information.

The identification information embedding unit 115 may embed information in order to specify the storage location of the photo data. The photo data wherein the identification information is embedded may be photo data wherein information for specifying the storage location of the photo data is embedded.

The identification information acquisition unit 118 may obtain information that designates the storage location of the photo data constituting the base data for the photo that was scanned.

Further, although not shown in FIG. 6, a deletion unit may be provided for monitoring the saving period that is included in the photo management information stored by the photo management information saving unit 116, and for deleting photo data for which the saving period has expired.

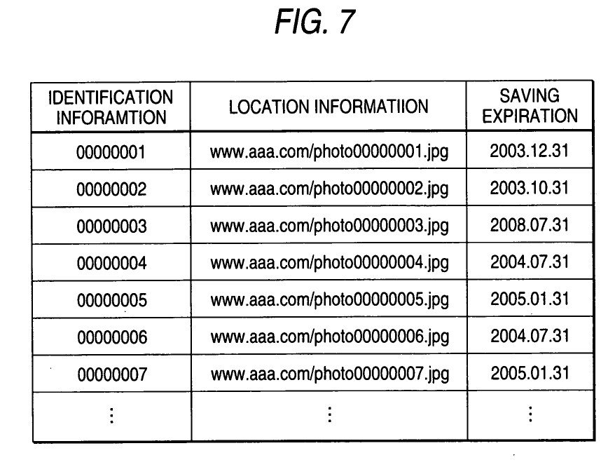

FIG. 7 is a diagram showing example photo management information that is stored by the photo management information saving unit 116.

As is shown in FIG. 7, the photo management information saving unit 116 stores, in the machine of a user or in a server, correlations among, for example, identification information for uniquely identifying photo data, location information indicating the storage location of photo data and the saving periods for the photo data.

The operation of the processing apparatus 11 for this embodiment will now be described.

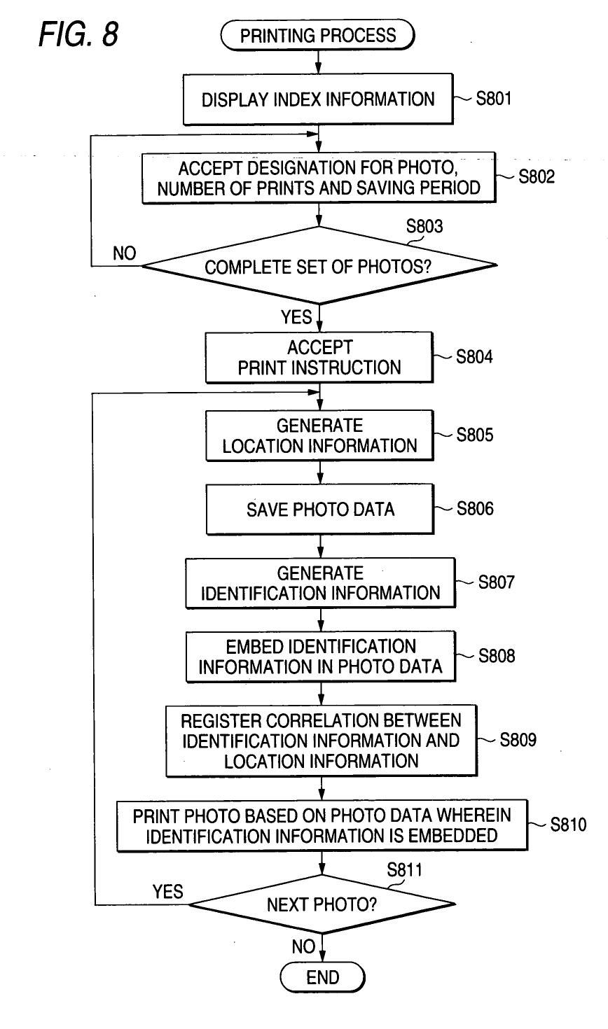

FIG. 8 is a flowchart showing the printing operation performed based on photo data.

First, the processing apparatus 11 reads index information (e.g., thumbnail images) for photos that have been recorded on a recording medium by the media reader 200, and displays the index information on the UI unit 300 (step S801). Then, when a user refers to the displayed index information and designates the number of prints and the saving period for a desired photo to be printed, the processing apparatus 11 accepts the designation through the UI unit 300 (step S802). A check is then performed to determine whether the selection has been completed for all the photos (step S803). When the selection has not been completed, program control returns to step S802. When the selection has been completed, a print start instruction from the user is accepted (step S804).

Then, the photo data acquisition unit 111 obtains, from the recording medium through the media reader 200, photo data for photos selected by the user.

Next, for one set of photo data obtained by the photo data acquisition unit 111, the location information generator 112 generates location information that indicates the storage location of the photo data (step S805). The location information can be directory information or file information for the processing apparatus 11 when the photo data are to be saved in the machine of the user, or can be a URL (Uniform Resource Locator) when the photo data are to be saved in the server.

The photo data saving unit 113 saves photo data at the storage location indicated by the thus generated location information (step S806).

Further, the identification information generator 114 generates identification information for uniquely identifying the photo data (step S807).

Then, the identification information embedding unit 115 embeds the identification information as a watermark in the photo data (step S808).

Thereafter, the photo management information saving unit 116 saves, in the machine of the user or in the server, photo management information representing correlations, as is shown in FIG. 7, among the identification information generated at step S807, the location information generated at step S805 and the information for the saving period accepted at step S802 (step S809). The information for the saving period may be stored as information for a saving expiration time obtained based on the current date and the saving period.

Finally, the printing instruction unit 105 designates, as print data, the photo wherein the watermark is embedded, and instructs the printer 520 to print the photo (step S810).

Then, the processing apparatus 11 determines whether there is a next photo (step S811). When there is a next photo, program control returns to step S805, but when there is no next photo, the processing is terminated.

Through this processing, the printer 520 prints the photo wherein the watermark constituting the identification information is embedded. The image of the thus printed photo is the same as that shown in FIG. 4.

In this embodiment as well as in the first embodiment, the watermark is embedded, for example, using the method for embedding a black dot pattern in a low-density area of a photo, or the method for embedding a dot pattern having a specific color in a portion wherein the complementary color is extended within a specific range.

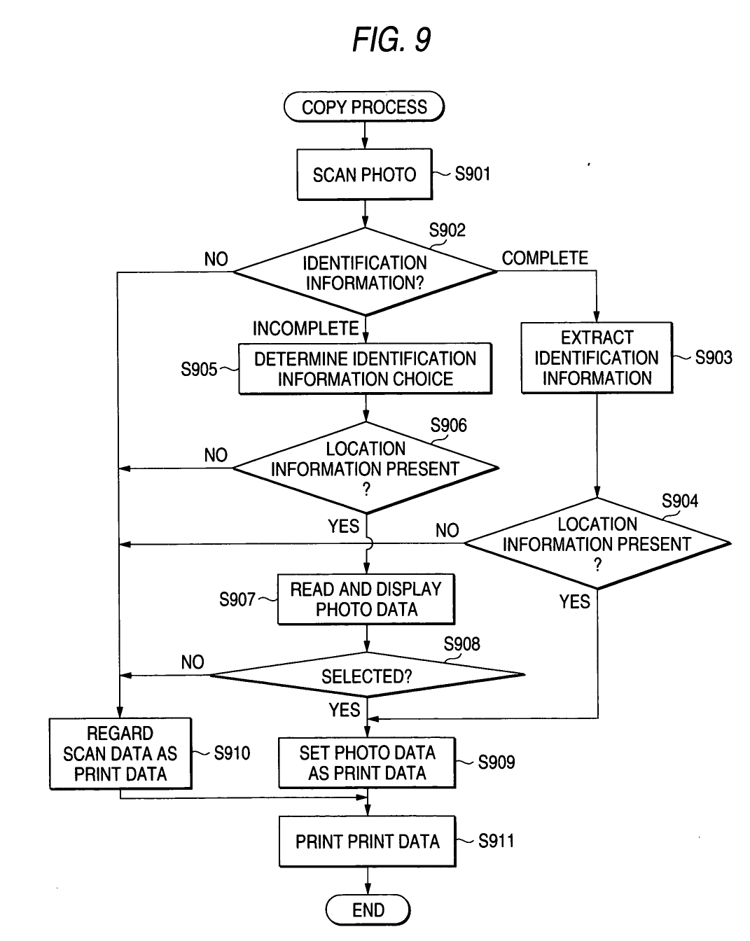

FIG. 9 is a flowchart showing the operation performed according to the embodiment for copying a printed photo.

First, the scanner 510 of the copier 500 scans a photo printed on paper of size L (step S901), and transmits the results to the processing apparatus 11. Then, the identification information acquisition unit 118 determines whether identification information can be extracted from the scanned photo (step S902).

The identification information acquisition unit 118 analyzes the photo scanning results in the same manner as when the identification information has been embedded, and tries to extract the identification information. When the identification information has been embedded in an easy-to-extract area, and when discoloration that makes the extraction of identification information difficult has not occurred in the photo, the identification information can be extracted by analyzing the scanning results obtained using the same procedures. However, in other cases, the identification information may not be extracted at all, or may be extracted only partially. Therefore, in this embodiment, three cases are assumed that are representative of the results obtained for a determination made when ascertaining whether identification information can be obtained: a case wherein complete identification information can be extracted, a case wherein identification information is extracted only incompletely (even though the obtained information is incomplete, complete identification information can be assumed by automatically compensating for the insufficient portion), and a case wherein identification information can not be extracted at all.

The identification information acquisition unit 118 extracts identification information when it is determined that the identification information can be extracted in its complete form (step S903). Then, the location information acquisition unit 219 determines whether location information correlated with the identification information is included in the photo management information previously stored by the photo management information saving unit 116 (step S904). When the location information is included, photo data are read from the storage location indicated by the location information and are designated as print data (step S909).

When it is determined at step S902 that the identification information can be extracted only in its incomplete form, the identification information acquisition unit 118 automatically compensates for part of the incomplete identification information, assumes the complete form of the identification information, and determines several identification information choices (step S905). Sequentially, the location information acquisition unit 219 determines whether sets of location information correlated with the identification information choices are included in the photo management information previously stored by the photo management information storage unit 116 (step S906). When correlated location information is present for the identification information choices, the photo data reader 107 reads photo data from the storage locations indicated by the location information and displays the photo data on the UI unit 300 (step S907). When the user selects a desired photo to be copied, the UI unit 300 accepts the selection (step S908). Then, the photo data reader 120 designates as print data the photo data for the selected photo (step S909).

When identification information can not at all be extracted at step S902, when location information is not present at step S904, when location information is not present at step S906, or when the selection is not entered at step S908, the photo scanned at step S901 is designated as print data directly (step S910).

The printing instruction unit 117 then instructs the printer 520 to print the print data (step S911), so that the printing of the photo is initiated.

In the flowchart in FIG. 9, when the identification information is obtained in the incomplete form, the complete identification information is assumed, and choices for a photo a user desires to copy are presented. However, for a system that can be employed by an unspecified large number of users, a privacy invasion may occur when photos owned by a specific user are presented to another user as choices for a photo to be copied. Therefore, if there is such a concern, when it is determined at step S902 that the identification information is incomplete, program control may not perform the processes at steps S905 to S908, and instead, advance to step S910, as well as when it is determined that identification information is absent.

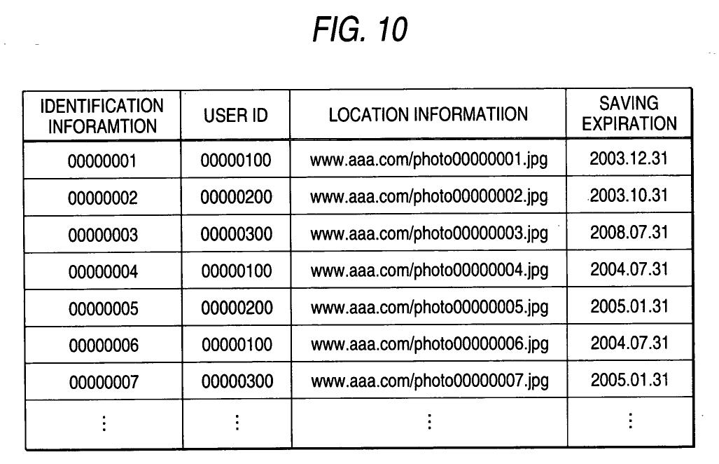

Or, assuming that a user has been registered in advance, choices for a photo that a user desires to copy may be selected from among photos the user saved in the past and presented. Specifically, user authentication is performed before the process in FIG. 8, at step S809. A user ID is registered in addition to, for example, the identification information and the location information. That is, the photo management information shown in FIG. 10 is registered. Further, user authentication is performed before the process in FIG. 9, at step S905, choices need only be determined using the identification information that is correlated with the user ID of the user. For example, when the user of user ID “00000100” requests copying, choices for the identification information are selected from, for example, “00000001”, “00000004” and “0000006”.

In this embodiment, the method used to charge for a service can be one incorporating a coin kit system. That is, wherein a condition is that a predetermined amount of money must be inserted into a coin-operated machine, the processes at steps S801 to S811 are performed for the printing process in FIG. 8, or the processes at steps S901 to S911 are performed for the copy process in FIG. 9.

Further, charging for a photo data storage service can also be performed during the printing of a photo. That is, a charging unit can be provided that requests at step S804 the insertion of an amount of money corresponding to the saving period designated at step S802, and that performs the processes at steps S805 to S811 when the condition has been satisfied by the insertion of the money.

As is described above, according to the embodiment, during the printing of a photo, photo data are saved in the machine of a user or in a server, and a correlation between location information, representing the storage location, and identification information, embedded in the photo, is maintained. Thus, during the copying of a photo, the storage location of the photo data can be designated based on the identification information embedded in the photo, and the photo data can be read from the storage location in the machine or in the server and can be printed. As a result, just as though the photo were being copied by a copier, a photo equivalent to the original photo can be printed using the photo data for the original photo.

### Third Embodiment

According to the third embodiment, an explanation will be given for a case wherein identification information is provided in advance for paper, for example, of size L that is printed based on photo data. As identification information, a management number may be printed on the reverse side of paper, or may be recorded on a wireless IC chip (e.g., U chip) embedded in the paper.

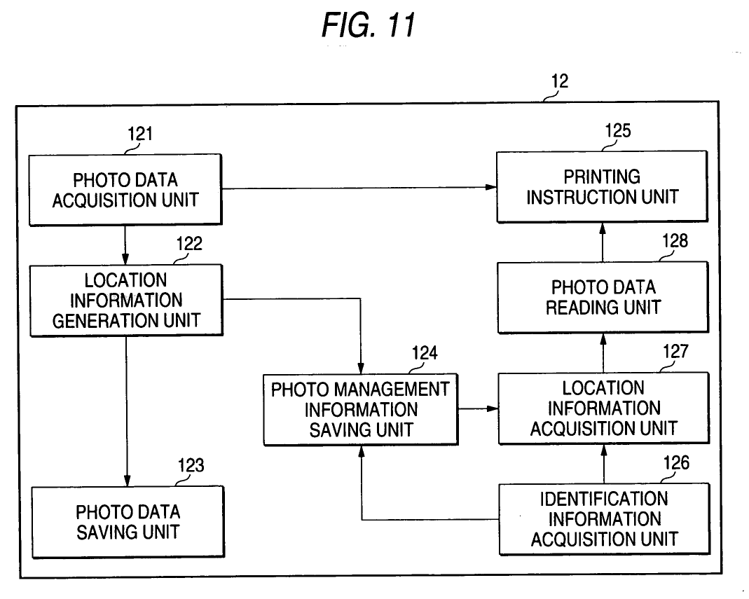

FIG. 11 is a block diagram showing a processing apparatus 12 according to the third embodiment.

As is shown in FIG. 11, the processing apparatus 12 of the third embodiment has: a photo data acquisition unit 121, a location information generator 122, a photo data saving unit 123, a photo management information saving unit 124, a printing instruction unit 125, an identification information acquisition unit 126, a location information acquisition unit 127 and a photo data reader 128.

The photo data acquisition unit 121 obtains photo data that are read by the media reader 200 and are designated using the UI unit 300. The location information generator 122 generates location information indicating the storage location of photo data. The photo data saving unit 123 saves photo data at the storage location indicated by the location information. The photo management information saving unit 124 saves photo management information, such as identification information provided for paper on which a photo is printed, and the location information. The printing instruction unit 125 issues an instruction to the printer 520 to perform printing based on designated print data. The identification information acquisition unit 126 extracts identification information from an image read by the scanner 510. The location information acquisition unit 127 obtains location information correlated with identification information. The photo data reader 128 reads photo data from the storage location indicated by the location information.

The identification information acquisition unit 126 may obtain information to specify the storage location of photo data that are the base for a photo that was scanned.

Further, although not shown in FIG. 11, a deletion unit may be provided for monitoring a saving expiration time that is included in the photo management information stored by the photo management information saving unit 124, and for deleting photo data for which the saving expiration time has been reached.

The operation of the processing apparatus 12 for this embodiment will now be explained.

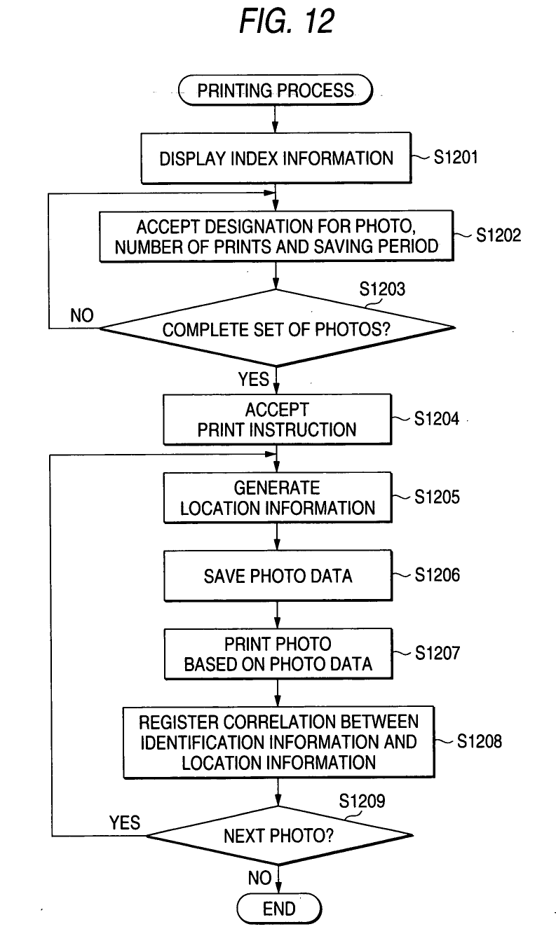

FIG. 12 is a flowchart showing the printing operation performed based on photo data.

First, the processing apparatus 12 reads index information (e.g., thumbnail images) for photos that are recorded on a recording medium by the media reader 200, and displays the information on the UI unit 300 (step S1201). Then, when a user examines the index information on the display and designates the number of prints and a saving period for a desired photo, the processing apparatus 12 accepts this designation through the UI unit 300 (step S1202). A check is then performed to determine whether the selection process has been completed for all the photos (step S1203). When the selection process has not yet been completed, program control returns to step S1202. When the selection process has been completed, a printing start instruction from the user is accepted (step S1204).

Thereafter, the photo data acquisition unit 121 obtains, from the recording medium through the media reader 200, photo data for photos selected by the user.

Following this, for one set of photo data obtained by the photo data acquisition unit 121, the location information generator 122 generates location information indicating a storage location whereat the photo data are to be saved (step S1205). The location information can be directory information or file information in the processing apparatus when the photo data are to be saved in the machine of the user, or can be URL (Uniform Resource Locator) when the photo data are to be saved in a server.

The photo data saving unit 123 saves photo data at a storage location indicated by the thus generated location information (step S1206).

The printing instruction unit 125 prints a photo based on the photo data (step S1207). The photo printed using this processing is not the photo shown in FIG. 4 in which a watermark is embedded, but a normal photo without a watermark embedded.

On the other hand, immediately before or after the printing processing, the printer 520 recognizes the identification information that is provided in advance for paper whereon a photo is printed. When the identification information is, for example, a management number printed on the reverse side of the paper, the management number is read by an OCR (Optical Character Reader) provided for the printer 520. When the identification information is a management number recorded on a wireless IC chip embedded in the paper, the management number is obtained by the wireless communication function of the printer 520. The identification information acquisition unit 118 receives the identification information.

The photo management information saving unit 116 saves, in the machine of a user or in a server, photo management information that represents the correlation between the thus obtained identification information, the location information generated at step S1205 and the saving period accepted at step S1202 (step S1208).

The photo management information saved here is, for example, as is shown in FIG. 7. It should be noted, however, that the identification information in this embodiment is not automatically generated, but is provided in advance for paper whereon a photo is printed and is viewed.

Or, the identification information may be registered in the machine of a user or in the server when paper whereon a photo is to be printed is obtained. In this case, at step S1208, identification information that has been read is searched for among the registered identification information, and location information and information for the saving period are registered in correlation with the identification information that is found.

The processing apparatus 12 determines whether there is a next photo (step S1209). When there is a next photo, program control returns to step S1205, or, if there are no more photos, the processing is terminated.

The operation in this embodiment for copying a printed photo is performed in the manner as shown in the flowchart in FIG. 9.

In this case, when the identification information is, for example, a management number printed on the reverse side of paper, at step S901, a double-sided scanner is employed as the scanner 510, so that the photo on the obverse side and the identification information on the reverse side can be scanned at the same time. A single-sided scanner may be employed as the scanner 510, so that the photo on the obverse side and the identification information on the reverse side can be scanned in a predetermined order. When the identification information is a management number recorded on a wireless IC chip embedded in the paper, the identification information can be obtained by the wireless communication function while the photo is being scanned by the scanner 510.

Furthermore, in this embodiment, as is described above, since a management number printed on the reverse side of paper, or a management number recorded on a wireless IC chip embedded in paper, is employed as identification information, it seems that very rarely is identification information obtained in an incomplete form. Therefore, when it is determined at step S902 that location information is incomplete, the processes at steps S905 to S908 may not be performed and program control may advance to step S910, as well as when there is no location information.

In this embodiment, the method used to charge for a service can be one incorporating a coin kit system. That is, on condition that a predetermined amount of money must be inserted into a coin-operated machine, the processes at steps S1201 to S1209 are performed for the printing process in FIG. 12, or the processes at steps S901 to S911 are performed for the copy process in FIG. 9.

Further, charging for a photo data storage service can also be performed during the printing of a photo. That is, a charging unit can be provided that requests at step S804 the insertion of an amount of money corresponding to the saving period designated at step S1202, and that performs the processes at steps S1205 to S1209 when the condition has been satisfied by the insertion of the money.

As is described above, according to the embodiment, during the printing of a photo, photo data are saved in the machine of a user or in a server, and a correlation among location information, representing the storage location, and identification information, provided in advance for paper, is maintained. Thus, during the copying of a photo, the storage location of the photo data can be designated based on the identification information provided for the paper, and the photo data can be read from the storage location in the machine or in the server and be printed. As a result, just as though the photo were being copied by a copier, a photo equivalent to the original photo can be printed using the photo data for the original photo.

In fourth to sixth embodiments that will be explained below, during the printing of a photo based on photo data, the photo data are stored in a user's machine or in a server, and information constituting a key for reading the stored photo data, and information indicating a permission level for printing based on the photo data are maintained, so that the use of the photo data for a photo that is printed is inhibited to prevent the unrestricted printing of photos having the same quality as the photo. It should be noted that a photo is printed on paper that is, for example, of size L.

### Fourth Embodiment

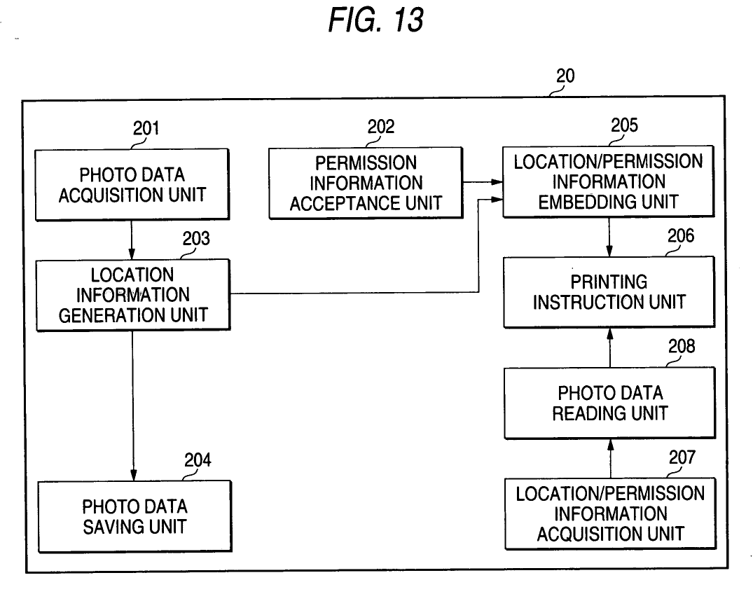

FIG. 13 is a block diagram showing a processing apparatus 20 according to the fourth embodiment.

As is shown in FIG. 13, the processing apparatus 20 of the fourth embodiment has: a photo data acquisition unit 201, a permission information acceptance unit 202, a location information generator 203, a photo data saving unit 204, a location/permission information embedding unit 205, a printing instruction unit 206, a location/permission information acquisition unit 207, and a photo data reader 208.

The photo data acquisition unit 201 obtains photo data that are read by the media reader 200 and are designated using the UI unit 300. The permission information acceptance unit 202 scans a printed photo and accepts permission information indicating the level of the permission for printing that is based on photo data. The location information generator 203 generates location information indicating the storage location of photo data. The photo data saving unit 204 saves photo data at the storage location indicated by the location information. The location/permission information embedding unit 205 embeds location information and permission information in the photo data. The printing instruction unit 206 issues an instruction to the printer 520 to perform printing based on designated print data. The location/permission information acquisition unit 207 extracts location information and permission information from an image that is read by the scanner 510. And the photo data reader 208 reads photo data from the storage location indicated by the location information when it is determined, based on the permission information, that printing based on photo data is to be permitted.

The location/permission information embedding unit 205 may embed information specifying the storage location of photo data and the permission level for printing that is based on the photo data. Further, the photo data in which the location information and the permission information are embedded may be the photo data in which information is embedded that specifies the storage location of the photo data, and the permission level for printing based on the photo data.

Furthermore, the location/permission information acquisition unit 207 may obtain information for specifying the storage location of photo data that are the base for a photo that was scanned, and to specify the permission level for printing based on the photo data.

The operation of the processing apparatus 20 for this embodiment will now be described.

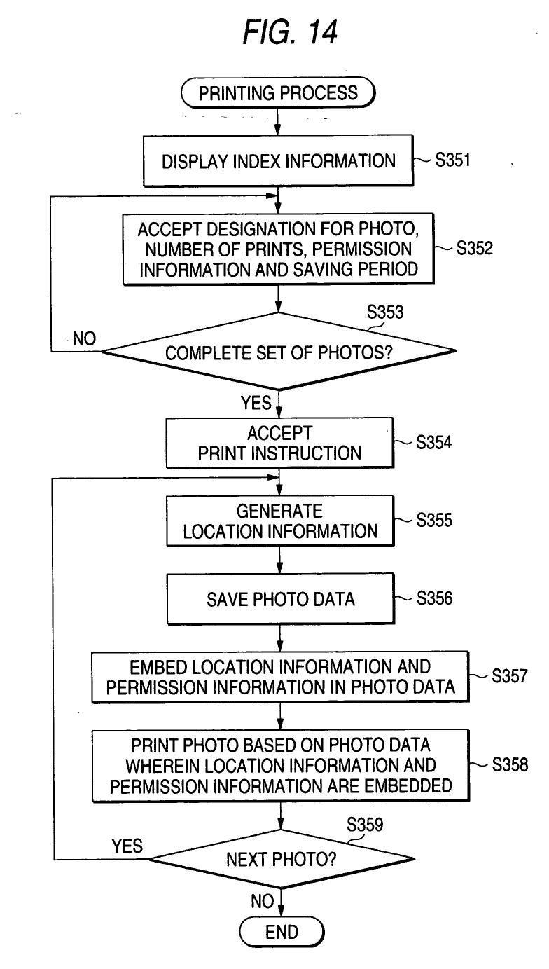

FIG. 14 is a flowchart showing the printing operation performed based on photo data.

First, the processing apparatus 20 reads index information (e.g., thumbnail images) of photos that are recorded on a recording medium by the media reader 200, and displays the index information on the UI unit 300 (step S351). Then, when a user refers to the displayed index information, and designates the number of prints, permission information and the saving period for a photo to be printed, the processing apparatus 20 accepts the designation entered through the UI unit 300 (step S352). The permission information is information for a permission level that is obtained by scanning a printed photo, and indicates the degree to which printing based on photo data should be permitted. Specifically, “inhibit copy”, which does not permit any printing based on photo data according to a result of scanning of a printed photo, “permit copy”, which unconditionally permits printing based on photo data according to a result of scanning of a printed photo, and “permit copy with password”, which conditionally permits printing based on photo data according to a result of scanning of a printed photo, with the condition that there is a matching password, can be designated. When such permission information is designated, the permission information acceptance unit 202 accepts this designation. Then, the processing apparatus 20 determines whether the selection has been completed for all the photos (step S353). When the selection has not yet been completed, program control returns to step S352; whereas when the selection has been completed, a print start instruction from the user is accepted (step S354).

Thereafter, the photo data acquisition unit 201 obtains, from a recording medium via the media reader 200, photo data for photos selected by the user.

Next, for one set of photo data obtained by the photo data acquisition unit 201, the location information generator 203 generates location information indicating a storage location whereat the photo data are to be saved (step S355). The location information available here can be directory information or file information for the machine of the user, when the photo data are to be saved in the machine, or can be a URL (Uniform Resource Locator), when the photo data are to be saved in a server.

The photo data saving unit 204 stores photo data at the storage location indicated by the thus generated location information (step S356). Also, at this time, the saving period for photo data may be transmitted to a computer wherein the photo data are stored, and when the saving period has expired, the photo data may be automatically deleted.

The location/permission information embedding unit 205 embeds location information and permission information as a watermark in photo data (step S357). When “permit copy with password” is designated as the permission information, a password designated by the user is also embedded as a watermark.

Finally, the printing instruction unit 206 designates as print data a photo wherein the watermark is embedded, and instructs the printer 520 to print the photo (step S358).

Then, the processing apparatus 20 determines whether there is a next photo (step S359). When there is a next photo, program control returns to step S355, but when there is no such photo, the processing is terminated.

Through this processing, the printer 520 is enabled to print a photo wherein a watermark, which indicates the location information and the permission information, are embedded. In FIG. 4 is shown an example photo that is thus printed. As is shown as in an enlarged circular area, the watermark is represented, for example, by a dot pattern. This dot pattern is not discernible to the naked eye of a human being who views the photo.

The dot pattern should not be one that appears naturally in photo data, but must be one for which it can be understood that it was intentionally embedded. As a first method for embedding such a dot pattern, a black dot pattern can be embedded in a low density area of a photo. For example, a pattern of tiny dots is embedded in the solid-white letters of the date (“103.07.071” in FIG. 4) in the photo. As a second method, in a portion wherein a single color is extended within a specific range, a dot pattern having a complementary color can be embedded.

Methods for embedding a watermark are not limited to these, and any method can be employed so long as a difference before and after a watermark has been embedded is not discernable to the human eye, but so long as the watermark can be detected when the photo is to be copied.

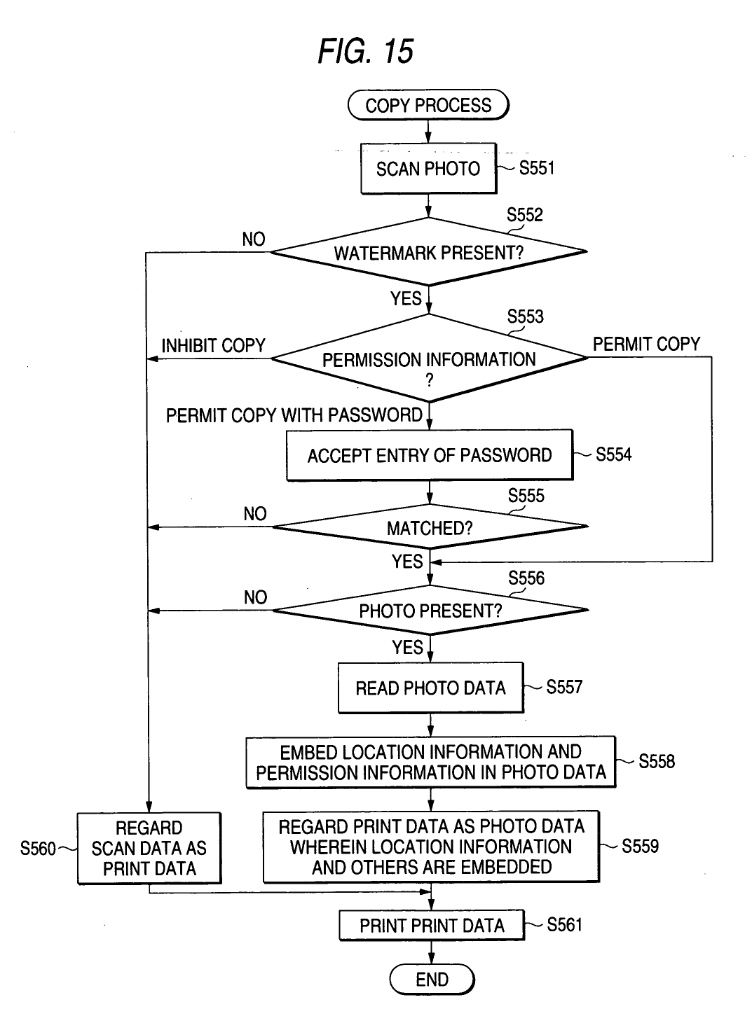

FIG. 15 is a flowchart showing the operation performed in this embodiment for copying a printed photo. When a watermark is included in the photo, strictly speaking, a printing process based on photo data that are the base for a photo is performed. However, in this embodiment, the expression “copy” is also employed for such a process.

First, when a user places on the platen of the copier 500 a sheet, of size L for example, with a photo printed thereon, and requests the copying of the photo, the scanner 510 scans the photo (step S551) and transmits the results to the processing apparatus 20. Then, the location/permission information acquisition unit 207 determines whether there is a watermark in the photo that was scanned (step S552).

When the location/permission information acquisition unit 207 determines that a watermark is present, the location/permission information acquisition unit 207 determines whether the permission information included in the watermark represents “inhibit copy”, “permit copy” or “permit copy with password” (step S553). When the permission information indicated is “permit copy with password”, the user is requested to enter a password. When a password is entered and is accepted (step S554), a check is performed to determine whether the input password matches a password included in the watermark (step S555). When the two passwords match or when it is determined at step S553 that the permission information indicates “permit copy”, the photo data reader 208 determines whether the photo data are present at the storage location indicated by the location information that is included in the watermark (step S556). Then, when the photo data are present and the photo data are read (step S557), and a watermark indicating the location information and the permission information are embedded in the photo that was read (step S558), the photo data in which the watermark has been embedded are designated as print data (step S559).

The watermark embedded in the photo that was scanned may be employed as a watermark to be embedded at step S558. When a user designates permission information that differs from the permission information embedded in the scanned photo, the information that includes both the location information embedded in the scanned photo and the designated permission information may be employed.

When it is determined at step S552 that a watermark is not present, when it is determined at step S553 that the permission information indicates “inhibit copy”, when the input password does not match the password included in the watermark at step S555, or when the photo data are not present at step S556, the photo scanned at step S551 is designated directly as print data (step S560).

Thereafter, the printing instruction unit 206 instructs the printer 520 to print the print data (step S561), and the printing of the photo is initiated.

In this embodiment, three types of permission information are assumed: “inhibit copy”, “permit copy” and “permit copy with password”; however, the permission information is not limited to these. For example, “permit copy with password” may be “permit copy with a condition”, which generally permits copy when a specific condition is satisfied in addition to a condition wherein passwords match.

Furthermore, in the flowchart in FIG. 15, the watermark is embedded at step S558. However, whether a watermark should be embedded may be asked of the user, and the watermark may be embedded only as instructed by the user. Further, a watermark including “inhibit copy” may be unconditionally embedded, so as to definitely inhibit the copying of a copy. Moreover, the process at step S558 may not be performed to avoid the embedding of the watermark.

In addition, in the flowchart in FIG. 15, the permission information is regarded as information for restricting the printing of a high-quality photo based on photo data that are stored in the machine of a user or in a server. When it is determined at step S553 that the permission information indicates “inhibit copy”, or when it is determined at step S553 that the permission information indicates “permit copy with password” and it is determined at step S555 that the passwords do not match, program control advances to steps S560 and S561, and the printing of scan data is enabled. However, the permission information may be regarded as information for restricting the normal copying of a photo that was scanned, and in the above cases, the processing may be forcibly terminated.

Further, at step S357 in FIG. 14 and at step S558 in FIG. 15, the location information may also be embedded in the photo data, and at step S556 in FIG. 15, the location information may be extracted from the watermark that is embedded in the photo. However, instead of being embedded as a watermark, the location information may be stored using another means during the printing, or may be supplied by another means during the copying.

In this embodiment, the method used to charge for a service can be one incorporating a coin kit system. That is, wherein a condition is that a predetermined amount of money must be inserted into a coin-operated machine, the processes at steps S351 to S359 are performed for the printing process in FIG. 14, or the processes at steps S551 to S561 are performed for the copy process in FIG. 15.

Further, charging for a photo data storage service can also be performed during the printing of a photo. That is, a charging unit can be provided that requests at step S354 the insertion of an amount of money corresponding to the saving period designated at step S352, and that performs the processes at steps S355 to S359 when the condition has been satisfied by the insertion of the money.

As is described above, according to this embodiment, during the printing of a photo, photo data are saved in the machine of a user or in a server, the permission level for printing based on photo data is designated, and the location information indicating a storage location and the permission information indicating the permission level are embedded in a photo. Thus, during copying of a photo, the storage location of the photo data and the permission level for printing can be designated based on the location information and the permission information that are embedded in the photo. When printing is permitted, the photo data can be read from the storage location in the machine or in the server and be printed. As a result, the usage of photo data for a printed photo can be inhibited, and the unrestricted printing of a photo having the same quality as the printed photo can be prevented.

### Fifth Embodiment

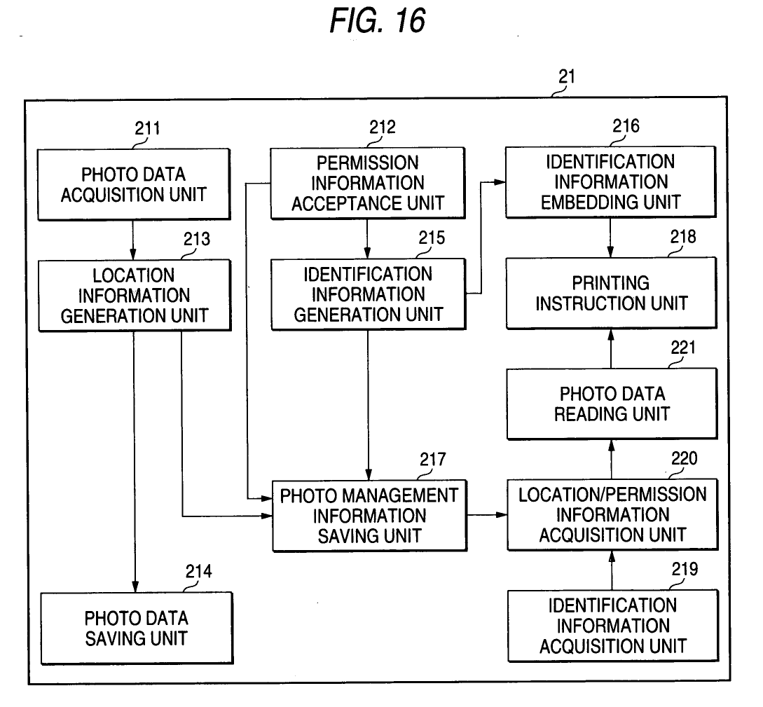

FIG. 16 is a block diagram showing a processing apparatus 21 according to the fifth embodiment.

As is shown in FIG. 16, the processing apparatus 21 of the fifth embodiment has: a photo data acquisition unit 211, a permission information acceptance unit 212, a location information generator 213, a photo data saving unit 214, an identification information generator 215, an identification information embedding unit 216, a photo management information saving unit 217, a printing instruction unit 218, an identification information acquisition unit 219, a location/permission information acquisition unit 220 and a photo data reader 221.

The photo data acquisition unit 211 obtains photo data that are read by the media reader 200 and are designated via the UI unit 300. The permission information acceptance unit 212 scans a printed photo and accepts permission information indicating the degree of permission for the printing based on photo data. The location information generator 213 generates location information indicating the storage location of photo data. The photo data saving unit 214 saves photo data at the storage location indicated by the location information. The identification information generator 215 generates identification information for uniquely identifying photo data. The identification information embedding unit 216 embeds identification information in photo data. The photo management information saving unit 217 saves photo management information that includes a correlation among identification information, location information and permission information. The printing instruction unit 218 issues an instruction to the printer 520 to perform printing based on designated print data. The identification information acquisition unit 219 extracts identification information from an image that is read by the scanner 510. The location/permission information acquisition unit 220 obtains location information and permission information that are correlated with the identification information. The photo data reader 221 reads photo data from the storage location indicated by the location information when it is determined, in accordance with the permission information, that printing based on photo data is to be permitted.

The identification information embedding unit 216 may embed information specifying the storage location of photo data. The photo data wherein the identification information is embedded may be photo data, wherein information is embedded for specifying the storage location of photo data.

The identification information acquisition unit 219 may obtain information for specifying the storage location of photo data that are the base for a photo that was scanned.

Further, although not shown in FIG. 16, a deletion unit may be provided for monitoring a saving expiration time that is included in the photo management information stored by the photo management information saving unit 217, and for deleting photo data for which the saving expiration time has been reached.

The operation of the processing apparatus 21 in this embodiment will now be described.

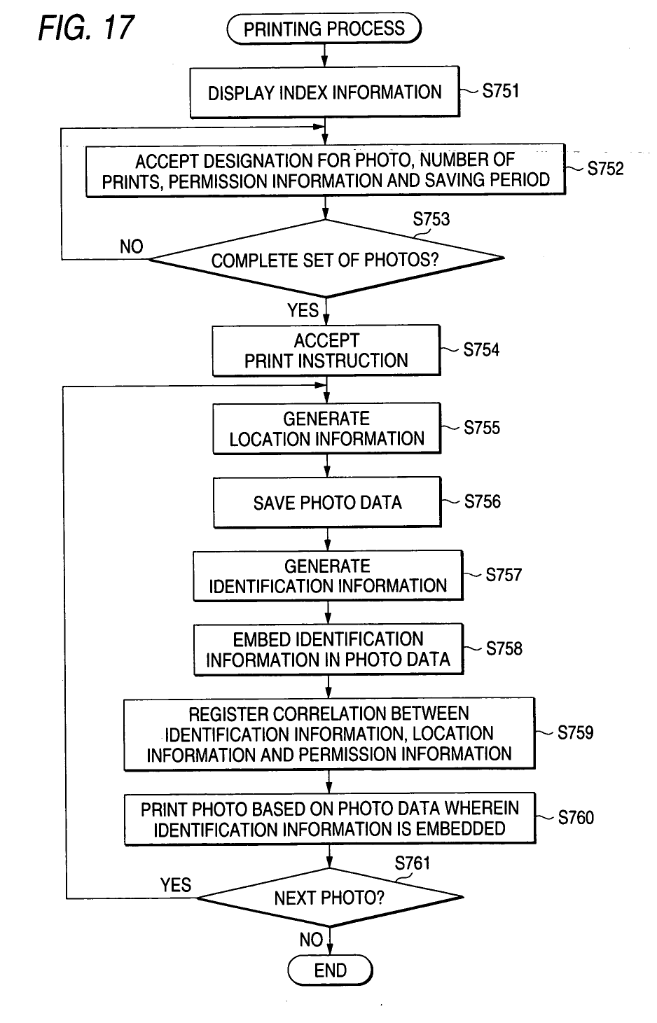

FIG. 17 is a flowchart showing the printing processing performed based on photo data.

First, the processing apparatus 21 reads index information (e.g., thumbnail image) for photos that are recorded on a recording medium by the media reader 200, and displays the index information on the UI unit 300 (step S751). Then, after a user has examined the displayed index information and has designated the number of prints, the permission information and the saving period for a photo to be printed, the processing apparatus 21 accepts the designation via the UI unit 300 (step S752). As well as in the fourth embodiment, the designated permission information can be “inhibit copy”, which does not permit any printing based on photo data according to a result of scanning of a printed photo, “permit copy”, which unconditionally permits printing based on photo data according to a result of scanning of a printed photo, and “permit copy with password”, which conditionally permits printing based on photo data according to a result of scanning of a printed photo under a condition wherein there is a password match. When such permission information is designated, the permission information acceptance unit 212 accepts the designation. Then, the processing apparatus 21 determines whether the selection has been completed for all the photos (step S753). When the selection has not yet been completed, program control returns to step S752, or when the selection has been completed, a print start instruction is accepted from the user (step S754).

Thereafter, the photo data acquisition unit 211 obtains from a recording medium, via the media reader 200, photo data for photos selected by the user.

Next, for one set of photo data obtained by the photo data acquisition unit 211, the location information generator 213 generates location information indicating a storage location whereat the photo data are to be saved (step S755). Here, the location information can be directory information or file information for the processing apparatus 21 when the photo data are to be saved in the machine of a user, or can be URL (Uniform Resource Locator) when the photo data are to be saved in a server.

The photo data saving unit 214 stores photo data at the storage location indicated by the thus generated location information (step S756).

Further, the identification information generator 215 generates identification information for uniquely identifying photo data (step S757).

Furthermore, the identification information embedding unit 216 embeds the identification information as a watermark in the photo data (step S758).

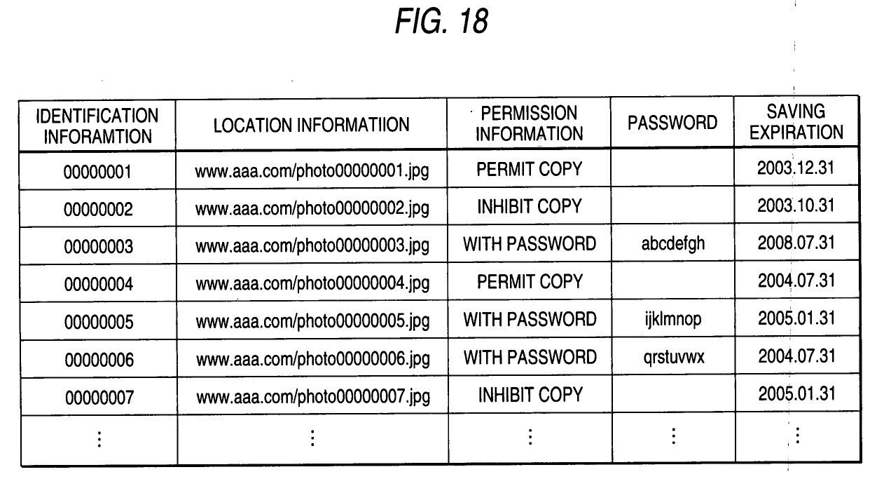

As is shown in FIG. 18, the photo management information saving unit 217 saves, in the machine of the user or in the server, photo management information representing a correlation among the identification information generated at step S757, the location information generated at step S755, and the permission information and the saving period information accepted at step S752 (step S759). It should be noted that when the permission information indicates “permit copy with password”, the password accepted at step S752 is also stored in correlation with this information. In addition, as is shown in FIG. 18, information for the saving expiration time, which is obtained based on the current date and the saving period, may be stored as information for the saving period.

Finally, the printing instruction unit 218 designates as print data, a photo wherein the watermark is embedded, and instructs the printer 520 to print the photo (step S760).

Thereafter, the processing apparatus 21 determines whether there is a next photo (step S761). When there is a next photo, program control returns to step S755, or when there are no more photos, the processing is terminated.

As a result of this processing, the printer 520 prints a photo wherein a watermark indicating the identification information is embedded. The image of the thus printed photo is as shown in FIG. 4.

In this embodiment, as well as in the fourth embodiment, a watermark is embedded, for example, using the method for embedding a black dot pattern in a low-density area of a photo, or the method for embedding a dot pattern of specific color in a portion wherein a complementary color is extended across a specific range.

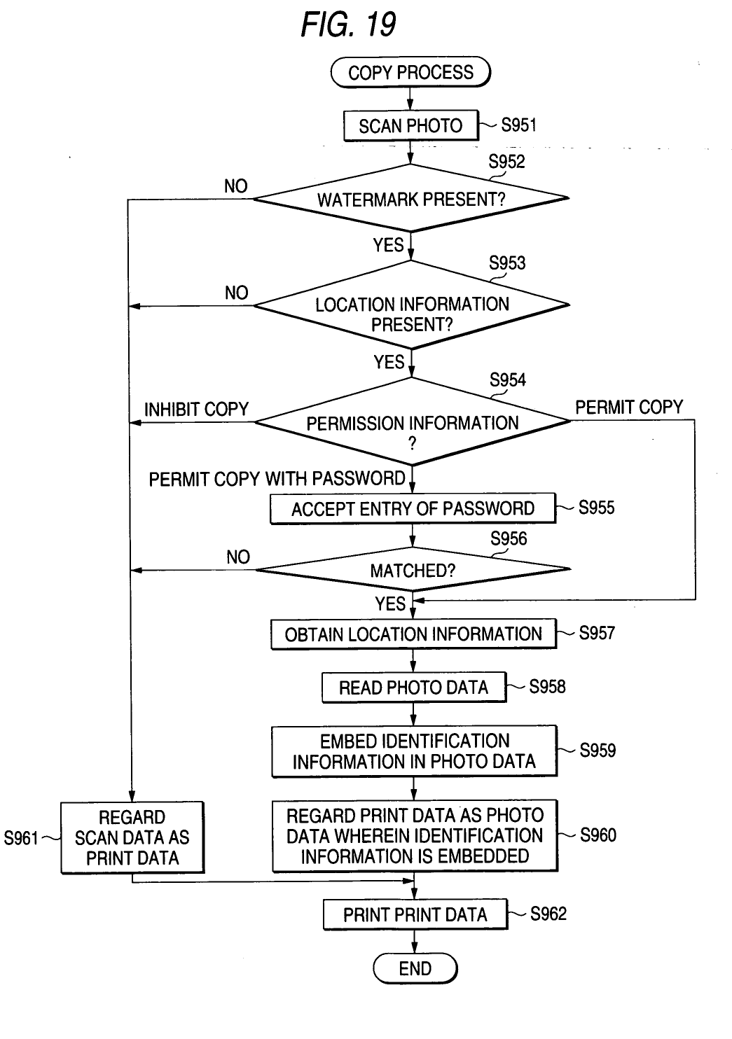

FIG. 19 is a flowchart showing the operation of the embodiment for copying a printed photo. When a watermark is included in a photo, strictly speaking, the printing operation is performed based on photo data that are the base for the photo. In this embodiment, however, as well as in the fourth embodiment, the expression “copy” is also employed for such processing.

First, when a user places, on the platen of the copier 500, a sheet of, for example, size L with a photo printed thereon, and requests the copying of the photo, the scanner 510 scans the photo (step S951), and transmits the results to the processing apparatus 21. Then, the identification information acquisition unit 219 determines whether there is a watermark in the photo that was scanned (step S952).

When it is determined that a watermark is included in the photo, the location/permission information acquisition unit 220 determines whether photo management information previously saved by the photo management information saving unit 217 includes photo management information wherein location information and permission information, for example, are correlated with identification information that is included in the watermark (step S953). When such photo management information is included, the location/permission information acquisition unit 220 determines whether permission information included in the photo management information represents “inhibit copy”, “permit copy” or “permit copy with password” (step S954). When the permission information represents “permit copy with password”, the user is requested to enter a password, and when the password is entered, it is accepted (step S955). A check is then performed to determine whether the input password matches a password included in the photo management information (step S956). When the passwords match, or when it is determined at step S954 that the permission information represents “permit copy”, the location/permission information acquisition unit 220 extracts location information from the photo management information (step S957), and the photo data reader 221 reads photo data from the storage location indicated by the location information (step S958). A watermark that represents identification information is embedded in the photo that has been read (step S959), and the photo data, with the watermark embedded, is designated as print data (step S960).

A watermark that was embedded in a photo that was scanned may be employed unchanged as a watermark to be embedded at step S959, or when a user designates permission information that differs from permission information correlated with the identification information that is embedded in the scanned photo, identification information that is newly provided for the designated permission information may be employed as a watermark. In the second case, for embedding a watermark at step S959, the following configuration, for example, can be employed. The identification information generator 215 generates new identification information, the photo management information saving unit 217 saves photo management information that includes a correlation between the newly generated identification information, location information obtained by the location/permission information acquisition unit 220 and the permission information designated by the user.

On the other hand, when it is determined at step S952 that a watermark is not present, when it is determined at step S953 that the pertinent photo management information is not present, when it is determined at step S954 that the permission information represents “inhibit copy”, or when the input password does not match the password included in the photo management information at step S956, the photo scanned at step S951 is designated directly as print data (step S961).

Then, the printing instruction unit 218 instructs the printer 520 to print the print data (step S962), so that the printing of the photo is initiated.

In this embodiment, three types of permission information are assumed: “inhibit copy”, “permit copy” and “permit copy with password”; however, the permission information is not limited to these. For example, “permit copy with password” may be “permit copy with a condition”, which generally permits copying when a specific condition is established in addition to a condition wherein passwords match.

Furthermore, in the flowchart in FIG. 19, the watermark is embedded at step S959. However, whether a watermark should be embedded may be asked of the user, and the watermark may be embedded only as instructed by the user. Further, a watermark including “inhibit copy” may be unconditionally embedded so as to definitely inhibit the copying of a copy. Moreover, the process at step S959 may not be performed to avoid the embedding of the watermark.

In addition, in the flowchart in FIG. 19, the permission information is regarded as information for restricting the printing of a high-quality photo based on photo data that are stored in the machine of a user or in a server. When it is determined at step S954 that the permission information indicates “inhibit copy”, or when it is determined at step S954 that the permission information indicates “permit copy with password” and it is determined at step S956 that the passwords do not match, program control advances to steps S961 and S962, and the printing of scan data is enabled. However, the permission information may be regarded as information for restricting the normal copying of a photo that was scanned, and in the above cases, the processing may be forcibly terminated.

Further, at step S759 in FIG. 17 and at step S959 in FIG. 19, the location information is also saved as photo management information, and at step S957 in FIG. 19, the location information is extracted from the photo management information. However, instead of being included in the photo management information, the location information may be stored by another means during the printing, or may be supplied by another means during the copying.

In this embodiment, the method used to charge for a service can be one incorporating a coin kit system. That is, wherein a condition is that a predetermined amount of money must be inserted into a coin-operated machine, the processes at steps S751 to S761 are performed for the printing process in FIG. 17, or the processes at steps S951 to S962 are performed for the copy process in FIG. 19.

Further, the charging for a photo data storage service can also be performed during the printing of a photo. That is, a charging unit can be provided that requests at step S754 the insertion of an amount of money corresponding to the saving period designated at step S752, and performs the processes at steps S755 to S761 under a condition wherein this money has been entered.

As is described above, according to this embodiment, during the printing of a photo, photo data are saved in the machine of a user or in a server, the permission level for printing based on photo data is designated, and a correlation is maintained between the identification information embedded in the photo, the location information indicating a storage location and the permission information indicating the permission level. Thus, during the copying of a photo, the storage location of the photo data and the permission level for printing can be designated based on the identification information embedded in the photo. When printing is permitted, the photo data can be read from the storage location in the machine or in the server and be printed. As a result, the usage of photo data for a printed photo can be inhibited, and the unrestricted printing of a photo having the same quality as the printed photo can be prevented.

### Sixth Embodiment

According to the sixth embodiment, an explanation will be given for a case wherein identification information is provided in advance for paper, for example, of size L that is printed based on photo data. As identification information, a management number may be printed on the reverse side of paper, or may be recorded on a wireless IC chip (e.g., μ chip) embedded in the paper.

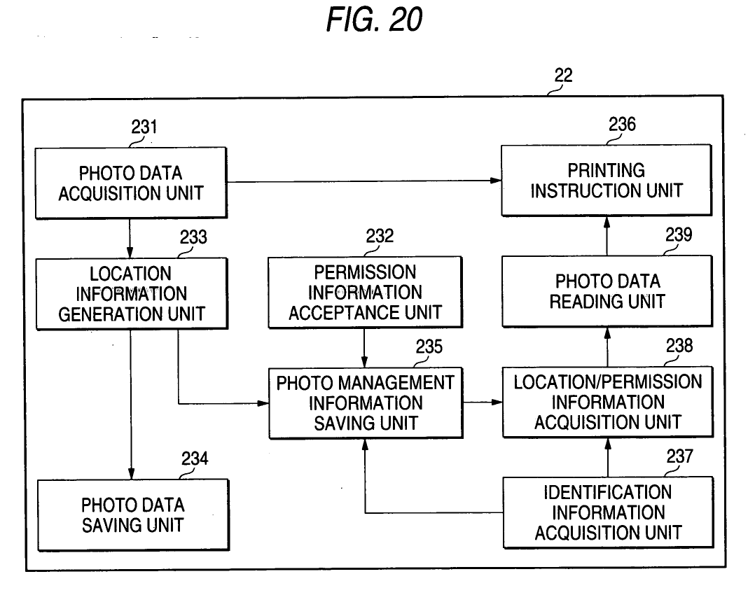

FIG. 20 is a block diagram showing a processing apparatus 22 according to the sixth embodiment.

As is shown in FIG. 20, the processing apparatus 22 of the sixth embodiment has: a photo data acquisition unit 231, a permission information acceptance unit 232, a location information generator 233, a photo data saving unit 234, a photo management information saving unit 235, a printing instruction unit 236, an identification information acquisition unit 237, a location/permission information acquisition unit 238 and a photo data reader 239.

The photo data acquisition unit 231 obtains photo data that are read by the media reader 200 and are designated using the UI unit 300. The permission information acceptance unit 232 scans a printed photo and accepts permission information that indicates the permission level for printing based on photo data. The location information generator 233 generates location information indicating the storage location of photo data. The photo data saving unit 234 saves photo data at the storage location indicated by the location information. The photo management information saving unit 235 saves photo management information that includes a correlation between identification information, provided for paper on which a photo is printed, the location information and the permission information. The printing instruction unit 236 issues an instruction to the printer 520 to perform printing based on designated print data. The identification information acquisition unit 237 extracts identification information from an image read by the scanner 510. The location/permission information acquisition unit 238 obtains location information and permission information correlated with identification information. The photo data reader 239 reads photo data from the storage location indicated by the location information when it is determined, in accordance with the permission information, that printing based on photo data is permitted.

The identification information acquisition unit 237 may obtain information to specify the storage location of photo data that are the base for a photo that was scanned.

Further, although not shown in FIG. 20, a deletion unit may be provided for monitoring a saving expiration time that is included in the photo management information stored by the photo management information saving unit 235, and for deleting photo data for which the saving expiration time has been reached.

The operation of the processing apparatus 22 for this embodiment will now be explained.

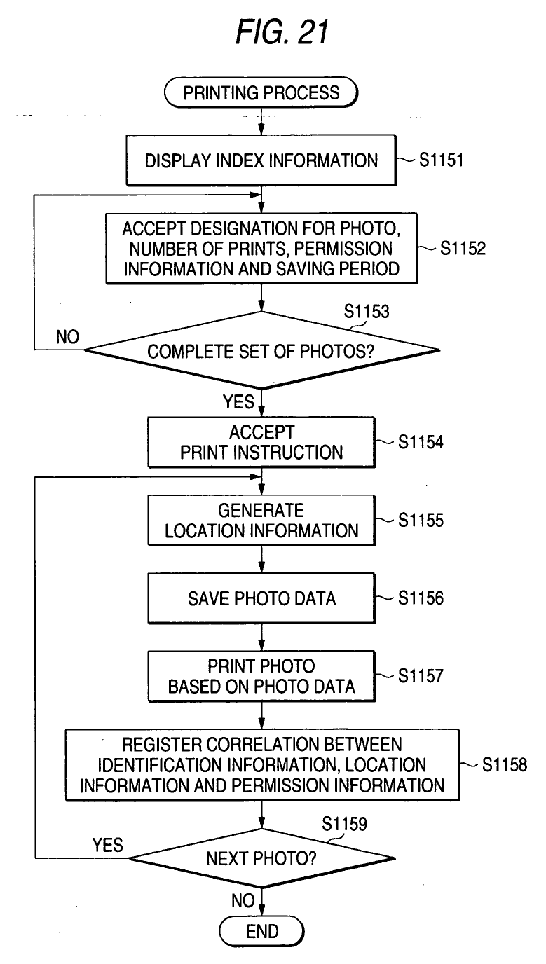

FIG. 21 is a flowchart showing the printing processing performed based on photo data.

First, the processing apparatus 22 reads index information (e.g., thumbnail image) for photos that are recorded on a recording medium by the media reader 200, and displays the index information on the UI unit 300 (step S1151). Then, after a user has examined the displayed index information and has designated the number of prints, the permission information and the saving period for a photo to be printed, the processing apparatus 22 accepts the designation via the UI unit 300 (step S1152). As well as in the fourth and fifth embodiments, the designated permission information can be “inhibit copy”, which scans a printed photo and does not permit any printing based on photo data, “permit copy”, which scans a printed photo and unconditionally permits printing based on photo data, and “permit copy with password”, which scans a printed photo and conditionally permits printing based on photo data under a condition wherein there is a password match. When such permission information is designated, the permission information acceptance unit 232 accepts the designation. Then, the processing apparatus 22 determines whether the selection has been completed for all the photos (step S1153). When the selection has not yet been completed, program control returns to step S1152, or when the selection has been completed, a print start instruction is accepted from the user (step S1154).

Thereafter, the photo data acquisition unit 231 obtains from a recording medium, via the media reader 200, photo data for photos selected by the user.

Next, for one set of photo data obtained by the photo data acquisition unit 231, the location information generator 233 generates location information indicating a storage location whereat the photo data are to be saved (step S1155). Here, the location information can be directory information or file information for the processing apparatus 22 when the photo data are to be saved in the machine of a user, or can be URL (Uniform Resource Locator) when the photo data are to be saved in a server.

The photo data saving unit 234 saves photo data at a storage location indicated by the thus generated location information (step S1156).

The printing instruction unit 236 prints a photo based on the photo data (step S1157). The photo printed using this processing is not the photo shown in FIG. 4 in which a watermark is embedded, but a normal photo without a watermark embedded.

On the other hand, immediately before or after the printing processing, the printer 520 recognizes the identification information that is provided in advance for paper whereon a photo is printed. When the identification information is, for example, a management number printed on the reverse side of the paper, the management number is read by an OCR (Optical Character Reader) provided for the printer 520. When the identification information is a management number recorded on a wireless IC chip embedded in the paper, the management number is obtained by the wireless communication function of the printer 520. The identification information acquisition unit 237 receives the identification information.

The photo management information saving unit 235 saves, in the machine of a user or in a server, photo management information that represents the correlation between the thus obtained identification information, the location information generated at step S1155, and the information for the permission information and the saving period that are accepted at step S1152 (step S1158).

The photo management information saved here is, for example, as is shown in FIG. 18. It should be noted, however, that the identification information in this embodiment is not automatically generated, but is provided in advance for paper whereon a photo is printed and is viewed.

Or, the identification information may be registered in the machine of a user or in the server when paper whereon a photo is to be printed is obtained. In this case, at step S1158, identification information that has been read is searched for among the registered identification information, and location information, permission information and information for the saving period are registered in correlation with the identification information that is found.

The processing apparatus 22 determines whether there is a next photo (step S1159). When there is a next photo, program control returns to step S1155, or, if there are no more photos, the processing is terminated.

The operation in this embodiment for copying a printed photo is performed in the manner as shown in the flowchart in FIG. 19.

In this case, when the identification information is, for example, a management number printed on the reverse side of paper, at step S951, a double-sided scanner is employed as the scanner 510, so that the photo on the obverse side and the identification information on the reverse side can be scanned at the same time. A single-sided scanner may be employed as the scanner 510, so that the photo on the obverse side and the identification information on the reverse side can be scanned in a predetermined order. When the identification information is a management number recorded on a wireless IC chip embedded in the paper, the identification information can be obtained by the wireless communication function while the photo is being scanned by the scanner 510.

The operation for this embodiment is terminated in the above described manner.

In this embodiment, three types of permission information are assumed: “inhibit copy”, “permit copy” and “permit copy with password”; however, the permission information is not limited to these. For example, “permit copy with password” may be “permit copy with a condition”, which generally permits copying when a specific condition is established in addition to a condition wherein passwords match.

Furthermore, in the flowchart in FIG. 19, the watermark is embedded at step S959. However, whether a watermark should be embedded may be asked of the user, and the watermark may be embedded only as instructed by the user. Further, a watermark including “inhibit copy” may be unconditionally embedded so as to definitely inhibit the copying of a copy. Moreover, the process at step S959 may not be performed to avoid the embedding of the watermark.

In addition, in the flowchart in FIG. 19, the permission information is regarded as information for restricting the printing of a high-quality photo based on photo data that are stored in the machine of a user or in a server. When it is determined at step S954 that the permission information indicates “inhibit copy”, or when it is determined at step S954 that the permission information indicates “permit copy with password” and it is determined at step S956 that the passwords do not match, program control advances to steps S961 and S962, and the printing of scan data is enabled. However, the permission information may be regarded as information for restricting the normal copying of a photo that was scanned, and in the above cases, the processing may be forcibly terminated.

Further, at step S1158 in FIG. 21 and at step S959 in FIG. 19, the location information is also saved as photo management information, and at step S957 in FIG. 19, the location information is extracted from the photo management information. However, instead of being included in the photo management information, the location information may be stored by another means during the printing, or may be supplied by another means during the copying.

In this embodiment, the method used to charge for a service can be one incorporating a coin kit system. That is, wherein a condition is that a predetermined amount of money must be inserted into a coin-operated machine, the processes at steps S1151 to S1159 are performed for the printing process in FIG. 21, or the processes at steps S951 to S962 are performed for the copy process in FIG. 19.

Further, the charging for a photo data storage service can also be performed during the printing of a photo. That is, a charging unit can be provided that requests at step S1154 the insertion of an amount of money corresponding to the saving period designated at step S1152, and performs the processes at steps S1155 to S1159 under a condition wherein this money has been entered.

As is described above, according to this embodiment, during the printing of a photo, photo data are saved in the machine of a user or in a server, the permission level for printing based on photo data is designated, and a correlation is maintained between the identification information provided in advance for a medium, such as paper, the location information indicating a storage location and the permission information indicating the permission level. Thus, during the copying of a photo, the storage location of the photo data and the permission level for printing can be designated based on the identification information provided for the medium. When printing is permitted, the photo data can be read from the storage location in the machine or in the server and be printed. As a result, the usage of photo data for a printed photo can be inhibited, and the unrestricted printing of a photo having the same quality as the printed photo can be prevented.

In the above embodiments, “photo” has been described as an example. The photo may include an animated image produced, for example, by using a computer.

What is claimed is:

1. A photo printing control apparatus, comprising:
a photo data saving unit which saves photo data in a storage unit in accordance with a request for photo printing based on the photo data;
an information embedding unit which embeds, in the photo data, information designating a storage location for the photo data, and thus generates advanced photo data; and
a printing instruction unit which instructs photo printing based on the advanced photo data that are generated by the information embedding unit.

2. The photo printing control apparatus according to claim 1, wherein the information embedding unit embeds, in the photo data, information specifying a permission level for printing based on the photo data.

3. The photo printing control apparatus according to claim 1, further comprising:
a location information generator for producing location information that indicates a storage location for the photo data,
wherein the photo data saving unit saves the photo data at a storage location indicated by the location information that is generated by the location information generator, and
the information embedding unit embeds, in the photo data, the location information generated by the location information generator.

4. The photo printing control apparatus according to claim 1, further comprising:
an identification information generator for generating identification information to identify the photo data;
a location information generator for generating location information indicating a storage location for the photo data; and
a photo management information saving unit which stores, in the storage unit, photo management information that includes a correlation between the identification information, generated by the identification information generator, and the location information, generated by the location information generator,
wherein the photo data saving unit saves the photo data in a storage location indicated by the location information that is generated by the location information generator, and
the information embedding unit embeds, in the photo data, the identification information generated by the identification information generator.

5. The photo printing control apparatus according to claim 1, further comprising:
a period setup unit which sets a period for saving the photo data in the storage unit; and
a charging unit which operates the photo data saving unit based on a charging condition corresponding to the period designated by the period setup unit.

6. A photo printing control apparatus, comprising:
a photo data saving unit which saves photo data in a storage unit in accordance with a request for photo printing based on the photo data;
a printing instruction unit which instructs printing of a photo based on the photo data;
an identification information acquisition unit which obtains identification information that is attached in advance to a medium on which the photo is printed; and
a photo management information saving unit which saves, in the storage unit, photo management information that includes a correlation between identification information, which is obtained by the identification information acquisition unit, and location information, which indicates a storage location for the photo data.

7. The photo printing control apparatus according to claim 6,
wherein the identification information acquisition unit obtains the identification information by recognizing characters that are printed in advance on a medium on which the photo has been printed.

8. The photo printing control apparatus according to claim 6,
wherein the identification information acquisition unit obtains the identification information by reading information from a wireless IC chip that is embedded in advance in a medium on which the photo has been printed.

9. A photo printing control apparatus, comprising:
an information acquisition unit, upon receiving a request for copying a photo, which extracts information from the photo to designate a storage location for photo data for the photo;
a photo data reading unit which reads photo data from the storage location designated in accordance with the information obtained by the information acquisition unit; and
a printing instruction unit which instructs photo printing based on the photo data obtained by the photo data reading unit.

10. The photo printing control apparatus according to claim 9,
wherein when information for specifying a storage location for the photo data is not extracted in a complete form from the photo, the information acquisition unit compensates for an insufficient portion of the information to obtain the complete form.

11. The photo printing control apparatus according to claim 9,
wherein the information acquisition unit obtains location information indicating a storage location for the photo data, and
the photo data reading unit reads the photo data from the storage location indicated by the location information that is obtained by the information acquisition unit.

12. The photo printing control apparatus according to claim 9,
wherein the information acquisition unit obtains identification information for identifying a photo, and
the photo data reading unit reads the photo data from a storage location indicated by location information that is correlated with the identification information obtained by the information acquisition unit.

13. The photo printing control apparatus according to claim 12,
wherein when the identification information in a complete form is not obtained, the information acquisition unit selects, from identification information provided for a photo for which copying has been requested,
identification information in the complete form wherein an insufficient portion has been compensated for.

14. A photo printing control method, comprising the steps of:
saving photo data in a storage unit in accordance with a request for photo printing based on the photo data;
embedding, in the photo data, information designating a storage location for the photo data, and thus generating advanced photo data; and
instructing photo printing based on the advanced photo data that are generated.

15. A photo printing control method, comprising the steps of:
saving photo data in a storage unit in accordance with a request for photo printing based on the photo data;
instructing printing of a photo based on the photo data;
obtaining identification information that is attached in advance to a medium on which the photo is printed; and
saving, in the storage unit, photo management information that includes a correlation between identification information, which has been obtained, and location information, which indicates a storage location for the photo data.

16. A photo printing control method, comprising the steps of:
upon receiving a request for copying a photo, extracting information from the photo to designate a storage location for photo data for the photo;
reading the photo data from the storage location designated in accordance with the obtained information; and
instructing photo printing based on the obtained photo data.

17. A program executed by a computer to perform the functions of:
saving image data in a storage unit in accordance with a request for image printing based on the image data;
embedding, in the image data, information designating a storage location for the image data, and thus generating advanced image data; and
instructing image printing based on the advanced image data that are generated.

18. A program executed by a computer to perform the functions of:
saving image data in a storage unit in accordance with a request for image printing based on the image data;
instructing printing of an image based on the image data;
obtaining identification information that is attached in advance to a medium on which the image is printed; and
saving, in the storage unit, image management information that includes a correlation between identification information, which is obtained, and location information, which indicates a storage location for the image data.

19. A program executed by a computer to perform the functions of:
upon receiving a request for copying an image, extracting information from the image to designate a storage location for image data for the image;
reading image data from the storage location designated in accordance with the obtained information; and
instructing image printing based on the obtained image data.

20. A photo printing control apparatus, comprising:
a photo data saving unit, upon receiving a request for photo printing based on photo data, which saves the photo data in a storage unit;
an information embedding unit which embeds information in the photo data to specify a permission level for printing based on the photo data, and thus generating advanced photo data; and
a printing instruction unit which instructs photo printing based on the advanced photo data generated by the information embedding unit.

21. The photo printing control apparatus according to claim 20, wherein the information embedding unit embeds, in the photo data, information specifying a storage location for the photo data.

22. The photo printing control apparatus according to claim 20, further comprising:
a permission information acceptance unit which accepts permission information that indicates a permission level for the printing,
wherein the information embedding unit embeds, in the photo data, the permission information accepted by the permission information acceptance unit.

23. The photo printing control apparatus according to claim 20, further comprising:
an identification information generator for generating identification information for identifying the photo data;
a permission information acceptance unit which accepts permission information that indicates a permission level for the printing; and
a photo management information saving unit which stores, in the storage unit, photo management information that includes a correlation between the identification information, generated by the identification information generator, and the permission information, accepted by the permission information acceptance unit,
wherein the information embedding unit embeds, in the photo data, the identification information generated by the identification information generator.

24. The photo printing control apparatus according to claim 20,
wherein information for specifying the permission level is information indicating one of permission for printing based on photo data, non-permission and permission with a condition.

25. A photo printing control apparatus, comprising:
a photo data saving unit, upon receiving a request for photo printing based on photo data, which saves the photo data in a storage unit;
a printing instruction unit which instructs the printing of a photo based on the photo data;
an identification information acquisition unit which obtains identification information that is attached in advance to a medium on which the photo is printed; and
a photo management information saving unit which saves photo management information that includes a correlation between the identification information, which is obtained by the identification information acquisition unit, and permission information, which indicates a permission level for performing printing based on the photo data.

26. The photo printing control apparatus according to claim 25,
wherein the identification information acquisition unit obtains the identification information by recognizing characters that have previously been printed on a medium on which the photo has been printed.

27. The photo printing control apparatus according to claim 25,
wherein the identification information acquisition unit obtains the identification information by reading information from a wireless IC chip previously embedded in a medium on which the photo has been printed.

28. A photo printing control apparatus, comprising:
an information acquisition unit, upon receiving a request to copy a photo, which extracts information from the photo to identify a permission level for printing based on photo data for the photo;
a photo data reading unit, when it is determined, based on the permission level designated by the information obtained by the information acquisition unit, that printing based on the photo data is permitted, which reads the photo data from the storage unit; and
a printing instruction unit which instructs photo printing based on the photo data that are read by the photo data reading unit.

29. The photo printing control apparatus according to claim 28,
wherein the information acquisition unit obtains permission information that indicates a permission level embedded in the photo, and
the photo data reading unit reads the photo data from the storage unit when it is determined, in accordance with the permission information obtained by the information acquisition unit, that printing based on the photo data is to be permitted.

30. The photo printing control apparatus according to claim 28,
wherein the information acquisition unit obtains identification information for identifying a photo, and
the photo data reading unit reads the photo data from the storage unit when it is determined, in accordance with permission information, which indicates a permission level correlated with the identification information obtained by the information acquisition unit, that printing based on the photo data is to be permitted.

31. A photo printing control apparatus, comprising:
an information acquisition unit, upon receiving a request to copy a photo, which extracts information from the photo to identify a permission level for printing based on photo data for the photo;
a photo data reading unit, when it is determined, based on the permission level designated by the information obtained by the information acquisition unit, that printing based on the photo data is permitted, which reads the photo data from the storage unit; and
a printing instruction unit which instructs photo printing based on advanced photo data, which are obtained by embedding, in the photo data read by the photo data reading unit, information for specifying a permission level for printing based on the photo data.

32. The photo printing control apparatus according to claim 31,
wherein the printing instruction unit instructs photo printing based on advanced photo data that are generated by embedding, in the photo data, permission information that indicates a designated permission level.

33. The photo printing control apparatus according to claim 31,
wherein the printing instruction unit instructs photo printing based on advanced photo data that are generated by embedding, in the photo data, identification information that is correlated with permission information indicating a designated permission level.

34. A photo printing control method, comprising the steps of:
upon receiving a request for photo printing based on photo data, saving the photo data in a storage unit;
embedding information in the photo data to specify a permission level for printing based on the photo data, and thus generating advanced photo data; and
instructing photo printing based on the advanced photo data that are generated.

35. A photo printing control method, comprising the steps of:
upon receiving a request for photo printing based on photo data, saving the photo data in a storage unit;
instructing the printing of a photo based on the photo data;
obtaining identification information that is attached in advance to a medium on which the photo is printed; and
saving photo management information that includes a correlation between the obtained identification information and permission information that indicates a permission level for performing printing based on the photo data.

36. A photo printing control method, comprising the steps of:
upon receiving a request to copy a photo, extracting information from the photo to identify a permission level for printing based on photo data for the photo;
when it is determined, based on the permission level designated by the obtained information, that printing based on the photo data is permitted, reading the photo data from the storage unit; and
instructing photo printing based on the photo data that are read.

37. A program executed by a computer to perform the functions of:
upon receiving a request for image printing based on image data, saving the image data in a storage unit;
embedding information in the image data to specify a permission level for printing based on the image data, and thus generating advanced image data; and
instructing image printing based on the advanced image data that are generated.

38. A program executed by a computer to perform the functions of:
upon receiving a request for image printing based on image data, saving the image data in a storage unit;
instructing the printing of an image based on the image data;
obtaining identification information that is attached in advance to a medium on which the image is printed; and
saving image management information that includes a correlation between the obtained identification information and permission information that indicates a permission level for performing printing based on the image data.

39. A program executed by a computer to perform the functions of:
upon receiving a request to copy an image, extracting information from the image to identify a permission level for printing based on image data for the image;
when it is determined, based on the permission level designated by the obtained information, that printing based on the image data is permitted, reading the image data from the storage unit; and
instructing image printing based on the image data that are read.
